(19) United States
(12) Patent Application Publication
(10) Pub. No.: US 2026/0338746 A1
(43) Pub. Date: Oct. 29, 2026

(54) VOID-BASED MACHINE LEARNING LOCALIZATION OF CHROMATOGRAPHIC PEAKS

(71) Applicant: Dionex Corporation, Sunnyvale, CA (US)

(72) Inventors: Andrew Theodore Zill, San Jose, CA (US); Yukiko Kawahara, San Jose, CA (US); Ryan Flis Gallagher, Morgan Hill, CA (US); Fabrice Lacout, Bouches-du-Rhone (FR); Carlos Amaury Escamilla Valdez, Baja, CA (US); Crystal Renae Welch, Aurora, CO (US)

(21) Appl. No.: 19/545,420

(22) Filed: Feb. 20, 2026

Related U.S. Application Data
(60) Provisional application No. 63/796,600, filed on Apr. 29, 2025.

(51) Int. Cl. G01N 30/86

(52) U.S. Cl. CPC G01N 30/8693; G01N 30/8631

(57) ABSTRACT

Systems or techniques are provided for facilitating void-based machine learning localization of chromatographic peaks. In various embodiments, a system can access a chromatogram of a sample scanned by a chromatograph. In various aspects, the system can identify for the sample a chromatographic peak that is nearest to a void dip of the chromatogram based on executing a peak-detection machine learning model on the chromatogram, wherein the peak-detection machine learning model can be trained on a training dataset whose annotated chromatograms collectively exhibit a range of void dip sizes or void dip locations. In various instances, the peak-detection machine learning model can receive as input the chromatogram and a characteristic location of the void dip associated with the chromatograph, and the peak-detection machine learning model can produce as output predicted integration limits for the chromatographic peak that is nearest to the void dip.

### CROSS-REFERENCE TO RELATED APPLICATIONS

This application claims priority to and the benefit of U.S. Provisional Application No. 63/796,600, entitled “Void-Based Machine Learning Localization of Chromatographic Peaks,” which was filed on Apr. 29, 2025. The entirety of the aforementioned application is hereby incorporated herein by reference.

### BACKGROUND

Detecting peaks in a chromatogram can be non-trivial.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate void-based machine learning localization of chromatographic peaks are described.

According to one or more embodiments, a system is provided. In various aspects, the system can comprise a processor that can execute computer-executable components stored in a non-transitory computer-readable memory. In various instances, the computer-executable components can comprise a scan component that can access a chromatogram of a sample scanned by a chromatograph. In various instances, the computer-executable components can comprise a peak component that can identify for the sample a chromatographic peak based on executing a peak-detection machine learning model on the chromatogram, wherein the peak-detection machine learning model can be trained on a training dataset whose annotated chromatograms collectively exhibit a range of void dip sizes or void dip locations. In various cases, the chromatographic peak can be nearest to a void dip of the chromatogram, the peak-detection machine learning model can receive as input the chromatogram and a characteristic location of the void dip associated with the chromatograph, and the peak-detection machine learning model can produce as output predicted integration limits for the chromatographic peak that is nearest to the void dip.

According to one or more embodiments, a computer-implemented method is provided. In various embodiments, the computer-implemented method can comprise accessing, by a device operatively coupled to a processor, a chromatogram of a sample scanned by a chromatograph. In various aspects, the computer-implemented method can comprise identifying, by the device, for the sample a chromatographic peak based on executing a peak-detection machine learning model on the chromatogram, wherein the peak-detection machine learning model can be trained on a training dataset whose annotated chromatograms collectively exhibit a range of void dip sizes or void dip locations. In various cases, the chromatographic peak can be nearest to a void dip of the chromatogram, the peak-detection machine learning model can receive as input the chromatogram and a characteristic location of the void dip associated with the chromatograph, and the peak-detection machine learning model can produce as output predicted integration limits for the chromatographic peak that is nearest to the void dip.

According to one or more embodiments, a computer program product for facilitating void-based machine learning localization of chromatographic peaks is provided. In various embodiments, the computer program product can comprise a non-transitory computer-readable memory having program instructions embodied therewith. In various aspects, the program instructions can be executable by a processor to cause the processor to cause a chromatograph to scan a sample, thereby yielding a chromatogram. In various instances, the program instructions can be further executable to cause the processor to predict integration limits and a retention time for a chromatographic peak that is nearest to a void dip of the chromatogram, based on executing a peak-detection machine learning model on the chromatogram, wherein the peak-detection machine learning model can be trained on a training dataset whose annotated chromatograms collectively exhibit a range of void dip sizes or void dip locations. In various cases, the program instructions can be further executable to cause the processor to render the integration limits and the retention time of the chromatographic peak that is nearest to the void dip on an electronic display. In various aspects, the peak-detection machine learning model can receive as input the chromatogram and a characteristic location of the void dip associated with the chromatograph.

### DESCRIPTION OF THE DRAWINGS

Various embodiments will be readily understood by the following detailed description in conjunction with the accompanying figures. To facilitate this description, like reference numerals designate like structural elements. Embodiments are illustrated by way of example, not by way of limitation, in the figures. The figures are not necessarily drawn to scale.

FIG. 1 illustrates an example, non-limiting block diagram of a scientific instrument module in accordance with various embodiments described herein.

FIG. 2 illustrates an example, non-limiting flow diagram of a computer-implemented method in accordance with various embodiments described herein.

FIG. 3 illustrates a block diagram of an example, non-limiting system that facilitates void-based machine learning localization of chromatographic peaks in accordance with one or more embodiments described herein.

FIG. 4 illustrates a block diagram of an example, non-limiting system including a chromatogram depicting a void dip that facilitates void-based machine learning localization of chromatographic peaks in accordance with one or more embodiments described herein.

FIG. 5 illustrates an example, non-limiting block diagram and pictorial illustration of a chromatogram depicting a void dip in accordance with one or more embodiments described herein.

FIG. 6 illustrates a block diagram of an example, non-limiting system including a peak-detection machine learning model and a near-void peak localization that facilitates void-based machine learning localization of chromatographic peaks in accordance with one or more embodiments described herein.

FIG. 7 illustrates an example, non-limiting block diagram showing how a near-void peak localization can be obtained by a peak-detection machine learning model in accordance with one or more embodiments described herein.

FIG. 8 illustrates a block diagram of an example, non-limiting system including a training component and a void-based training dataset that facilitates void-based machine learning localization of chromatographic peaks in accordance with one or more embodiments described herein.

FIG. 9 illustrates an example, non-limiting block diagram of a void-based training dataset in accordance with one or more embodiments described herein.

FIG. 10 illustrates an example, non-limiting block diagram showing how a peak-detection machine learning model can be trained in accordance with one or more embodiments described herein.

FIG. 11 illustrates an example, non-limiting block diagram showing how a void-based training dataset can be augmented or expanded in accordance with one or more embodiments described herein.

FIGS. 12-15 illustrate graphical recreations of example, non-limiting experimental results in accordance with one or more embodiments described herein.

FIG. 16 illustrates a block diagram of an example, non-limiting operating environment in which one or more embodiments described herein can be facilitated.

FIG. 17 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Various operations can be described as multiple discrete actions or operations in turn, in a manner that is most helpful in understanding the subject matter disclosed herein. However, the order of description should not be construed as to imply that these operations are necessarily order dependent. In particular, these operations can be performed in an order different from the order of presentation. Operations described can be performed in a different order from the described embodiments. Various additional operations can be performed, or described operations can be omitted in additional embodiments.

Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices. As used herein, the phrase “based on” should be understood to mean “based at least in part on,” unless otherwise specified.

A chromatograph (also referred to as a chromatography device) can be considered as a type of scientific instrument that can be deployed in a scientific, laboratory, research, or clinical operational context or setting, so as to determine (e.g., when employed in conjunction with a downstream detector such as a conductivity detector or a mass spectrometer) the chemical composition or make-up of unknown samples or specimens. To facilitate such chemical composition determination, the chromatograph can comprise a complex arrangement of actuatable parts (e.g., ion sources, ion lenses, heaters, coolers, columns such an a high-performance liquid chromatography column or an ion exchange column, ovens, injectors, fluid valves, fluid pumps, circuit switches), sensors (e.g., ion detectors, voltmeters, thermistors, potentiometers, pressure gauges), or consumables (e.g., carrier fluids, calibrants, filters).

During a scan, a portion of any given sample can be injected into the chromatograph and thus pass through whatever constituent pieces of hardware (e.g., oven-heated column) that make up the chromatograph. The chromatograph can be structured or designed so as to cause different chemical species (e.g., molecules, compounds, analytes, ions) within the injected portion of the sample to elute (e.g., to be physically separated or isolated from the remainder of the injected portion of the sample) at different times. How much time is required for any particular chemical species to elute can be referred to as a retention time of that particular chemical species. The chromatograph can be configured to generate a chromatogram, which can be considered as a graph of intensity (e.g., magnitude of detector signal recorded by the chromatograph) as a function of retention time. Peaks in the chromatogram can correspond to elution, and thus high concentrations, of respective chemical species, whereas valleys in the chromatogram can instead correspond to no elution of chemical species (e.g., valleys can be the product of mere noise captured by the detector of the chromatograph, the absence of the eluent, or the presence of any species that produces a lower signal than the eluent background).

In order to determine the specific identities of the chemical species that make up the injected portion of the sample, the peaks in the chromatogram should first be located, and those peaks (or their corresponding mass spectra that are produced by a downstream mass spectrometer) can be evaluated or analyzed so as to determine which chemical species they represent. Chromatographic peak localization can be facilitated in two distinct ways. In some cases, chromatographic peak localization can be facilitated by utilizing heuristic peak-detection protocols. Such protocols are explicitly-programmed software scripts or packages that identify chromatographic peaks via non-machine-learning computations (e.g., thresholding, local maxima detection, derivative computations, curve fitting). In other cases, chromatographic peak localization can be facilitated by utilizing machine learning models. Such models are trained to receive chromatograms as input and to locate peaks in those chromatograms as output.

Unfortunately, both of the aforementioned ways of facilitating chromatographic peak localization can suffer from void interference. In particular, a chromatogram can contain what is referred to as a void dip. A void dip is a negative intensity signal that appears in the chromatograph's baseline shortly after injection of a sample and which can be attributed to the passage of unretained or weakly retained components, such as water, through the oven-heated column of the chromatograph. Chromatographic peaks caused by early-eluting chemical species (e.g., fluoride in ion exchange chromatography) can be temporally close or near to the void dip, which can cause such peaks to become partially or fully disfigured by, hidden by, or overlapping with the void dip. In other words, such peaks can be interfered with by the void dip. Such interference can significantly increase a level of difficulty associated with localizing early-eluting or near-void peaks. Indeed, for early-eluting or near-void chromatographic peaks whose heights are small compared to (e.g., not on the same order as) that of the void dip, chromatographic peak localization via heuristic protocols or machine learning will often fail to even detect such peaks (e.g., will often mistake such a peak as being a transient tail of the void dip). Additionally, for early-eluting or near-void chromatographic peaks whose heights are large compared to (e.g., on the same order as) that of the void dip, although chromatographic peak localization via heuristic protocols or machine learning will often detect such peaks, they frequently grossly overestimate the widths of such peaks (e.g., will often erroneously conclude that such peaks start much earlier or end much later than they actually do). Accordingly, void interference can be considered as being a significant technical problem that adversely impacts the ability to correctly or reliably located peaks within chromatograms.

Existing techniques attempt to address void interference by increasing peak resolution, such that all peaks, including early-eluting or near-void peaks, visually appear to be more noticeable or conspicuous in chromatograms. Such existing techniques facilitate increased peak resolution via advanced column chemistries or via increased eluent strengths. However, as the present inventors realized, applying existing techniques to a given chromatograph will often have the unintended side-effect of causing all peaks detected by that given chromatograph to be shifted closer to the void dip. If an early-eluting peak has higher resolution but is also temporally closer to the void dip, it does not necessarily become easier to localize such peak. After all, although such peak might be less likely to be totally missed or ignored by chromatographic peak localization; such peak becomes more likely to have its width erroneously determined (e.g., becomes more likely to have its end time grossly overestimated). In other words, any increase in peak resolution achieved by existing techniques can be considered as being offset or cancelled by increased closeness to the void dip. Thus, existing techniques can be considered as being disadvantageous.

Accordingly, systems or techniques that can ameliorate such technical problems can be desirable.

Various embodiments described herein can address one or more of these technical problems. One or more embodiments described herein can include systems, computer-implemented methods, apparatus, or computer program products that can facilitate void-based machine learning localization of chromatographic peaks. In particular, the present inventors realized that chromatographic peak localization can more accurately or reliably be performed by a machine learning model, if that machine learning model has been configured to implicitly or explicitly take void dips into account.

More specifically, a machine learning model is often referred to as a black-box, due to the fact that its internal parameters (e.g., weight matrices, convolutional kernels) have no clearly, readily, easily, or transparently interpretable meanings. After all, the process of training the machine learning model can be considered as a mathematical procedure in which those internal parameters are iteratively increased or decreased so as to maximize the likelihood that the machine learning model will produce a correct output (e.g., a peak localization) in response to any given input (e.g., a chromatogram). This means that the machine learning model can be considered as deciding for itself what specific features, aspects, or details of the given input to focus or rely on when producing the output, as opposed to a user or technician forcing the machine learning model to focus or rely on certain features, aspects, or details. In some situations, the machine learning model can mistakenly learn to focus or rely on features, aspects, or details of the input that, in actuality, are irrelevant to the output. In other situations, the machine learning model can mistakenly learn to give no or little focus or reliance on features, aspects, or details of the input that, in actuality, are relevant to the output.

With these general observations in mind, the present inventors realized that the problem of void interference can be reduced by forcing a machine learning model to take void dips into account when localizing chromatographic peaks. In some instances, as described herein, forcing the machine learning model to take void dips into account can be accomplished implicitly by curating whatever dataset on which the machine learning model is trained such that the dataset spans or represents not just a varied range or spectrum of peak sizes or locations, but also a varied range or spectrum of void dip sizes or locations. Contrast this with existing techniques that curate chromatographic peak localization training datasets to span or represent only a varied range or spectrum of peak sizes or locations. In other instances, as described herein, forcing the machine learning model to take void dips into account can be accomplished explicitly by configuring the machine learning model to receive as input not just a chromatogram but also a location (e.g., a retention time interval) at which the void dip is expected to occur within the chromatogram (e.g., although the size of a void dip can vary with operational parameter configuration of a given chromatograph, the location of the void dip can be fairly consistent, and thus predictable or repeatable, for the given chromatograph regardless of operational parameter configuration). Contrast this with existing techniques that configure machine learning models to receive as input only chromatograms (e.g., such that the machine learning model is not apprised of the location at which the void dip is expected to occur). In any case, forcing the machine learning model to pay attention to, focus on, or otherwise take void dips into account implicitly or explicitly can significantly improve the ability of the machine learning model to distinguish void dips from early-eluting or near-void peaks (e.g., can significantly reduce the likelihood that the machine learning model fails to detect a near-void peak or grossly overestimates a width of the near-void peak).

Various embodiments described herein can be considered as a computerized tool (e.g., any suitable combination of computer-executable hardware or computer-executable software) that can be electronically installed on or otherwise with respect to a chromatograph and that can facilitate void-based machine learning localization of chromatographic peaks. In various aspects, such computerized tool can comprise a scan component, a peak component, or an execution component.

In various embodiments, the chromatograph can include or be made up of any suitable constituent hardware (e.g., gas chromatography hardware, liquid chromatography hardware, ion chromatography hardware). As some non-limiting examples, the chromatograph can comprise any suitable sample injector (e.g., hot injectors such as split, splitless, direct, or gas sampling valve (GSV); cold injectors such as cold on column (COC) or programmed temperature vaporization (PTV); injection syringe; infusion syringe; vaporizer; nebulizer), any suitable chromatography column (e.g., comprising any suitable absorbent packing material or any suitable capillary with different stationary phase films), any suitable column oven or heater, or any suitable carrier fluid flow devices (e.g., fluid valves, fluid pumps). In various aspects, any suitable autosampler or auxiliary sampling devices can pair with chromatography hardware to perform sample preparation and introduction (e.g., gas and liquid sampling valve, headspace autosampler, solid phase microextraction (SPME), headspace-SPME; in-tube extraction-dynamic headspace (ITEX-DHS), thermal desorbers (TD), purge and trap samplers (P&T), pyrolyzers). In various instances, carrier gas species can non-limitingly include helium, hydrogen, nitrogen, argon, methane, or any suitable combination thereof. In various cases, when given any sample, the sample can be injected into the chromatograph, and the sample can be separated into various compositional components by the chromatograph. In some instances, those various compositional components can be ionized and subsequently analyzed by any suitable mass spectrometer that is downstream of the chromatograph (e.g., the mass spectrometer can record relative abundances of sample ions as a function of mass-to-charge ratio). In various aspects, the chromatograph can be loaded with a certain sample.

In various instances, the chromatograph can be associated with a characteristic void location. In various cases, the characteristic void location can be a retention time interval (e.g., defined between some first retention time value and some second retention time value that is greater than the first retention time value) in which void dips are expected to occur in chromatograms produced by the chromatograph. Note that the chromatograph can be considered as having any suitable selectable or configurable operating parameters (e.g., column type, column temperature, eluent flow rate, detector sensitivity). Moreover, note that the particular values or states of those selectable or configurable operating parameters can influence or affect the sizes (e.g., heights, widths) of void dips detected by the chromatograph (e.g., setting the selectable or configurable operating parameters to a certain combination of values or states can cause void dips detected by the chromatograph to have some certain height; setting the selectable or configurable operating parameters to some other combination of values or states can cause void dips detected by the chromatograph to have some other height). However, note that the particular values or states of those selectable or configurable operating parameters can have little to no influence or effect on the locations (e.g., retention times) of void dips detected by the chromatograph (e.g., no matter what values or states to which the selectable or configurable operating parameters are set, the void dips detected by the chromatograph across multiple scans can occur at or near the same retention times as each other with little variance). Thus, in some aspects, the characteristic void location can be empirically determined for the chromatograph (e.g., can be equal to an average location of void dips exhibited by multiple chromatograms previously produced by the chromatograph).

In various embodiments, the computerized tool can electronically access the chromatograph. That is, the computerized tool can electronically interface or communicate with the chromatograph, such that any components of the computerized tool can electronically interact with (e.g., send electronic commands to, read electronic signals from) the chromatograph.

In various embodiments, the scan component of the computerized tool can electronically cause the chromatograph to inject a portion of the loaded sample. The scan component can accordingly cause the chromatograph to scan that portion of the loaded sample. In various aspects, the chromatograph can perform such scan using any suitable scanning protocol. In any case, such scanning can yield a chromatogram. The chromatogram can be a plurality of time-intensity tuples (e.g., a graph or plot of measured intensities as a function of retention time). In various aspects, the chromatogram can depict, illustrate, or otherwise contain a void dip, which can be a pronounced or prominent negative intensity signal.

In various embodiments, the peak component of the computerized tool can electronically store, maintain, control, or otherwise access a peak-detection machine learning model. In various aspects, the peak-detection machine learning model can exhibit any suitable artificial intelligence architecture. For instance, in some cases, the peak-detection machine learning model can exhibit any suitable deep learning internal architecture. For example, the peak-detection machine learning model can include any suitable numbers of any suitable types of layers (e.g., input layer, one or more hidden layers, output layer, any of which can be convolutional layers, dense layers, long short-term memory (LSTM) layers, transformer layers, non-linearity layers, pooling layers, batch normalization layers, or padding layers). As another example, the peak-detection machine learning model can include any suitable numbers of neurons in various layers (e.g., different layers can have the same or different numbers of neurons as each other). As yet another example, the peak-detection machine learning model can include any suitable activation functions (e.g., softmax, sigmoid, hyperbolic tangent, rectified linear unit) in various neurons (e.g., different neurons can have the same or different activation functions as each other). As still another example, the peak-detection machine learning model can include any suitable interneuron connections or interlayer connections (e.g., forward connections, skip connections, recurrent connections). In other instances, the peak-detection machine learning model can exhibit any other suitable artificial intelligence architecture, such as a support vector machine architecture, a linear or logistic regression architecture, a naïve Bayes architecture, or a decision tree architecture.

Regardless of its specific internal architecture, the peak-detection machine learning model can be configured to localize chromatographic peaks that are nearest or closest to void dips within inputted chromatograms. In some instances, such localization can take the form of predicting or inferring integration limits of those chromatographic peaks (e.g., the retention times at which those chromatographic peaks begin and end). In other instances, such localization can take the form of predicting or inferring the individual retention times at which those chromatographic peaks occur (e.g., the specific instants or moments of maximum detected intensity of each of those chromatographic peaks). In any case, the peak component can execute the peak-detection machine learning model on the chromatogram, and such execution can cause a near-void peak of that chromatogram to be localized. For instance, suppose that the peak-detection machine learning model exhibits a deep learning architecture. In such case, the peak component can concatenate the chromatogram and the characteristic void location together, and the peak component can feed that concatenation to an input layer of the peak-detection machine learning model. In various instances, that concatenation can complete a forward pass through one or more hidden layers of the peak-detection machine learning model, and an output layer of the peak-detection machine learning model can localize (e.g., calculate integration limits or a retention time for) the near-void peak.

In various aspects, the near-void peak can be a contiguous string or sequence of time-intensity tuples that are inferred, predicted, or otherwise determined by the peak-detection machine learning model to collectively form whatever peak within the chromatogram that is temporally, and thus visually, closest to the void dip. In other words, the chromatogram can depict multiple different peaks at respective retention times, and the near-void peak can be whichever one of those multiple peaks occurs most near to the void dip.

Note that, because the peak-detection machine learning model can receive as input not just the chromatogram but also the characteristic void location, the peak-detection machine learning model can be referred to as being conditioned on the characteristic void location. In other words, the peak-detection machine learning model can be considered as being explicitly forced to focus on whatever retention times are normally or usually associated with void dips when localizing the near-void peak. In still other words, the peak-detection machine learning model can be considered as being explicitly forced to pay special or extra attention to whichever portion or segment of the chromatogram within which the void dip is expected to occur. By being configured to receive the characteristic void location as a supplemental or complementary input argument, the peak-detection machine learning model can be considered as exhibiting heightened or increased sensitivity to variations in void dips (e.g., variations in void height, variations in void width), as compared to situations in which the peak-detection machine learning model were instead configured to receive only the chromatogram as an input argument. Such heightened or increased sensitivity can cause the peak-detection machine learning model to be more likely to accurately or reliably localize the near-void peak (e.g., can reduce a probability that the width of the near-void peak is grossly overestimated; can reduce a probability that the near-void peak is completely missed or ignored).

In various embodiments, the execution component of the computerized tool can electronically perform or initiate any suitable electronic actions based on the near-void peak. For instance, the execution component can render the near-void peak (e.g., its integration limits or retention time) on any suitable electronic screen. As another instance, the execution component can integrate (e.g., compute an area-under-curve value for) the near-void peak. As another instance, the execution component can perform any suitable type of statistical, numerical, or computational analysis on any mass spectra (e.g., produced by a downstream mass spectrometer) that correspond to the near-void peak.

In order for various embodiments described herein to function properly, the peak-detection machine learning model can first be trained. In various aspects, the computerized tool can include a training component that can facilitate such training (e.g., in supervised fashion) as described later herein. In various instances, such training can be facilitated using a void-based training dataset. In various cases, the void-based training dataset can include a multitude of training chromatograms, each corresponding to a respective ground-truth near-void peak localization (e.g., ground-truth integration limits or retention times for whatever peaks are known or deemed to be nearest or closest to the void dips of those training chromatograms). In situations where the peak-detection machine learning model is configured to receive not just chromatograms as input but also characteristic void locations, each training chromatogram in the void-based training dataset can also correspond to a training characteristic void location (e.g., two or more training chromatograms can have been created or recorded by the same chromatograph as each other, and so they can correspond to the same characteristic void location as each other; two or more training chromatograms can have been created or recorded by different chromatographs than each other, and so they can correspond to different characteristic void locations than each other). In any case, the multitude of training chromatograms can span or otherwise represent a varied or diverse range of void dip sizes or locations. In other words, two or more different or distinct void heights, two or more different or distinct void widths, two or more different or distinct void starting times, or two or more different or distinct void ending times can be included or represented within the multitude of training chromatograms. In some instances, this can be achieved by manually curating the void-based training dataset (e.g., by purposely selecting for inclusion in the void-based training dataset chromatograms that exhibit differently-shaped void dips). In other instances, this can be achieved via automated augmentation performed by the training component (e.g., for any given chromatogram that is included in the void-based training dataset, the training component can produce a copy of that given chromatogram and can locally scale the void dip depicted in that copy).

In any case, the void-based training dataset being representative of a wide range or spectrum of void dip variation can implicitly force the peak-detection machine learning model to learn how such void dip variation influences or affects near-void peak localizations. In other words, the breadth or representativeness of the void-based training dataset can cause the peak-detection machine learning model to exhibit heightened or increased sensitivity to variations in void dips, as compared to situations in which the peak-detection machine learning model were instead trained on a dataset whose chromatograms did not span or represent such void variability. As above, such heightened or increased sensitivity can cause the peak-detection machine learning model to be more likely to accurately or reliably localize the near-void peak. Note that, even in situations where the peak-detection machine learning model is configured to receive only chromatograms as input (e.g., is not configured to receive characteristic void locations as input), the peak-detection machine learning model can nevertheless exhibit heightened or increased sensitivity to void variability, due to the void-based training dataset.

Various embodiments described herein can be employed to use hardware or software to solve problems that are highly technical in nature (e.g., to facilitate void-based machine learning localization of chromatographic peaks), that are not abstract and that cannot be performed as a set of mental acts by a human. Further, some of the processes performed can be performed by a specialized computer (e.g., chromatograph which can inject and scan portions of samples; machine learning model which can be composed of specific types of neural network layers) for carrying out defined acts related to chromatography.

For example, such defined acts can include: accessing, by a device operatively coupled to a processor, a chromatogram of a sample scanned by a chromatograph; and identifying, by the device, for the sample a chromatographic peak that is nearest to a void dip of the chromatogram based on executing a peak-detection machine learning model on the chromatogram, wherein the peak-detection machine learning model is trained on a training dataset whose annotated chromatograms collectively exhibit a range of void dip sizes or locations. In various instances, the peak-detection machine learning model can receive as input the chromatogram and a characteristic location of the void dip associated with the chromatograph, and the peak-detection machine learning model can produce as output predicted integration limits or a retention time for the chromatographic peak that is nearest to the void dip. In some cases, such defined acts can include: expanding, by the device, the training dataset, based on copying annotated chromatograms and locally scaling respective void dips exhibited by copied annotated chromatograms.

Such defined acts are inherently computerized. Indeed, chromatographs are highly-technical computerized devices comprising specific computerized hardware (e.g., temperature sensors, pressure sensors, voltage sensors, ion beam emitters, ion focusing lenses, ion detectors, oven-heated columns, autosamplers). Neither a chromatograph nor the operations that it performs can be implemented by the human mind, or by a human with pen and paper, in any reasonable or practicable way without computers (e.g., neither the human mind nor a human with pen and paper can inject portions of samples into or through the oven-heated columns or detectors of a chromatograph). Additionally, machine learning models (e.g., artificial neural networks) are also inherently computerized constructs comprising specific software-oriented architectures (e.g., input layers, hidden layers, or output layers, any of which can be made up of trainable or non-trainable internal parameters such as convolutional layers or LSTM layers). Machine learning models cannot be trained or executed by the human mind, or by humans with mere pen and paper, in any reasonable or practicable way without computers.

Moreover, various embodiments described herein can integrate into a practical application various teachings relating to chromatography. As explained above, it can be desired to localize peaks within a chromatogram (e.g., mass spectra of those localized peaks can then be subsequently analyzed to identify which chemical species were responsible for creating or causing those localized peaks). Peak localization can be performed either via heuristic protocols (e.g., derivative computations, thresholding, local maxima searching) or machine learning. In either case, peak localization is vulnerable to void interference. That is, peaks that are near in time to a void dip can be exceptionally difficult to accurately or reliably localize, since the void dip can partially or fully hide or disfigure such peaks. Existing techniques attempt to address void interference by increasing peak resolution via improved column or eluent chemistries. Higher-resolution peaks are more visually conspicuous and thus easier to localize. However, improved column or eluent chemistries have the unintended side-effect of shifting all peaks closer to the void dip, thereby increasing the amount of overlap or interference that the void dip imparts onto the nearest or closest peak. So, when existing techniques are implemented, any increase in peak resolution can be considered as being nullified or outweighed by the concomitant increase in closeness between peaks and the void dip. In other words, existing techniques for addressing void interference do not confidently or reliably address void interference.

Various embodiments described herein can help to ameliorate such technical problems by facilitating void-based machine learning localization of chromatographic peaks. In particular, the present inventors realized that a machine learning model that has been trained to perform chromatographic peak localization can overcome or otherwise become substantially robust against the problem of void interference, when that machine learning model is forced to pay attention to void dips. In some cases, such force can be implicit, such as by curating whatever dataset on which the machine learning model is trained to be representative of the variety of void dip sizes or locations that the machine learning model might encounter during deployment. In other cases, such force can be explicit, such as by configuring the machine learning model to receive as input not just a chromatogram produced by a chromatograph but also a retention time interval during which the chromatograph is normally or usually expected to detect void dips. In either case, forcing the machine learning model to focus on void dips when performing the task of chromatographic peak localization can ultimately cause the machine learning model to be better able to distinguish void dips from chromatographic peaks that overlap with or are disfigured by those void dips. Thus, various embodiments described herein can exhibit increased peak localization accuracy or reliability as compared to existing techniques.

Additionally, the counter-intuitive character of various embodiments described herein must be emphasized. As explained above, existing techniques teach that void interference should be dealt with by increasing peak resolution via column chemistry changes or eluent chemistry changes. So, a person of ordinary skill in the art who wanted to address the problem of void interference would have attempted to find better column or eluent chemistries (e.g., chemistries that increase resolution without causing as much toward-void peak shift), rather than investigating how to improve the localization accuracy or reliably of machine learning peak detectors. Even if such person were interested in increasing the localization accuracy or reliability of a machine learning peak detector, such person would have had no reason whatsoever to implement the herein-described void-based changes in machine learning architecture or training. At most, if given a trained machine learning peak detector, such person might have attempted to increase the localization accuracy or reliability of that trained machine learning peak detector by subjecting it to additional training. However, no matter the volume or amount of such additional training, such additional training would not address the problem of void interference if the dataset used during such additional training does not span or represent variability or diversity in void size or location. Accordingly, forcing a machine learning peak detector to pay attention to void dips, either implicitly via a training dataset that is curated to be representative of void variability or explicitly by configuring the machine learning peak detector to receive characteristic void locations as supplementary input arguments, can be considered as clever, unusual, or counter-intuitive ways of addressing the problem of void interference.

For at least these reasons, various embodiments described herein can be considered as a concrete and tangible technical improvement in the field of chromatography. Accordingly, various embodiments described herein certainly qualify as useful and practical applications of computers.

Furthermore, various embodiments described herein can control real-world tangible devices based on the disclosed teachings. For example, various embodiments described herein can electronically activate, deactivate, or otherwise actuate real-world hardware (e.g., sample injectors, ion beam emitters, ion focusing lenses, carrier fluid valves/pumps) of real-world chromatographs.

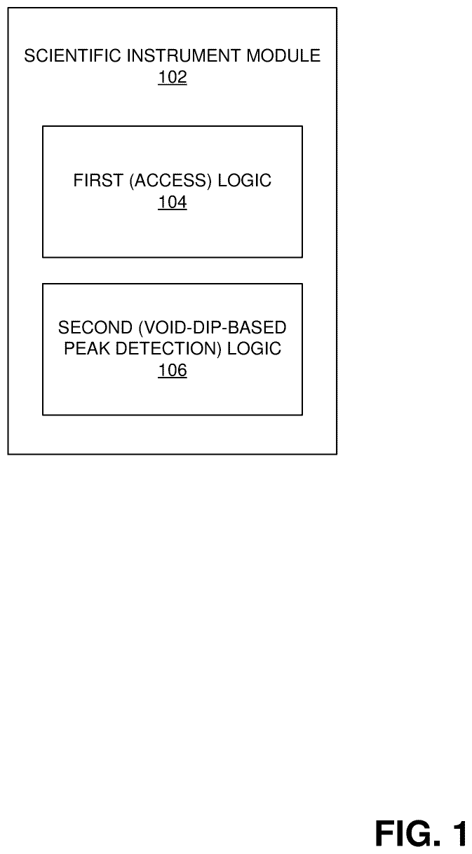

FIG. 1 illustrates an example, non-limiting block diagram of a scientific instrument module 102 in accordance with various embodiments described herein.

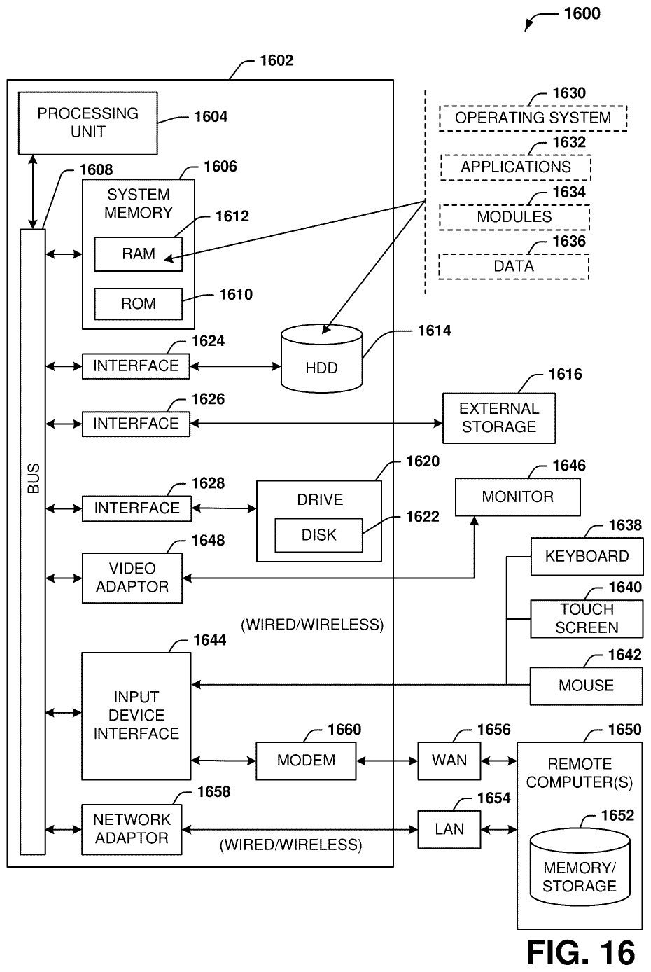

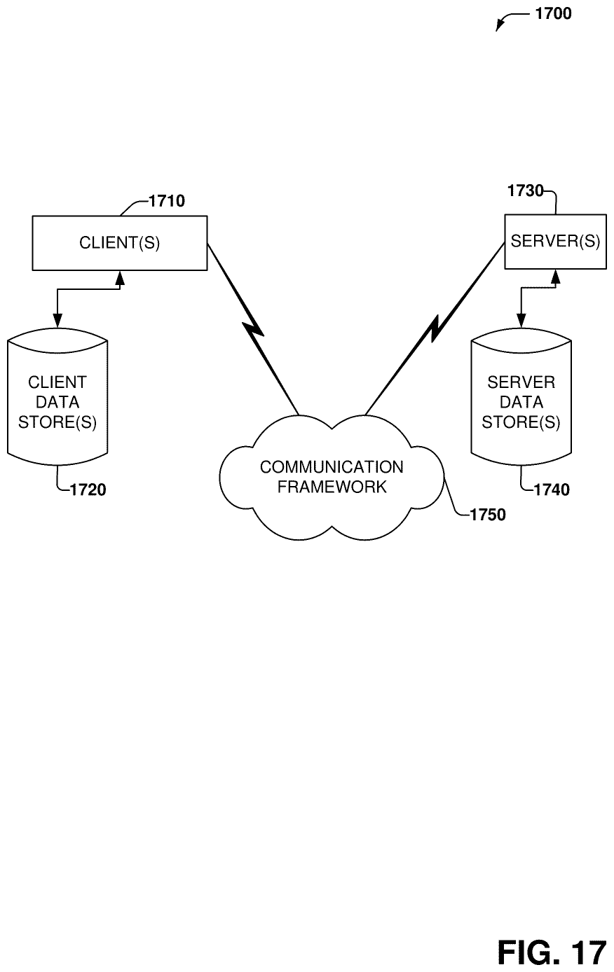

In various embodiments, the scientific instrument module 102 can be implemented by circuitry (e.g., including electrical or optical components), such as a programmed computing device. Logic of the scientific instrument module 102 can be included in a single computing device or can be distributed across multiple computing devices that are in communication with each other as appropriate. Examples of computing devices that may, singly or in combination, implement the scientific instrument module 102 are discussed herein with reference to FIG. 16, and examples of systems or networks of interconnected computing devices, in which the scientific instrument module 102 may be implemented across one or more of the computing devices, are discussed herein with reference to FIG. 17.

The scientific instrument module 102 can include first logic 104 and second logic 106. As used herein, the term “logic” can include an apparatus that is to perform a set of operations associated with the logic. For example, any of the logic elements included in the scientific instrument module 102 can be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” can refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module can omit one or more of the logic elements depicted in the associated drawings; for example, a module may include a subset of the logic elements depicted in the associated drawings when that module is to perform a subset of the operations discussed herein with reference to that module.

In various embodiments, there can be a scientific instrument corresponding to the scientific instrument module 102. In various aspects, the scientific instrument can be any suitable computerized device that can electronically measure some scientifically-relevant, clinically-relevant, or research-relevant characteristic, property, or attribute of an analytical sample (e.g., of a known or unknown mixture, compound, or collection of matter). As a non-limiting example, a scientific instrument can be a chromatograph. In such case, the scientific instrument can measure or capture chromatograms (e.g., relative abundance as a function of retention time) of the analytical sample.

In various embodiments, the first logic 104 can access (e.g., obtain, receive, retrieve) a chromatogram of the analytical sample scanned by the scientific instrument.

In various embodiments, the second logic 106 can identify a chromatographic peak that is nearest to a void dip of the chromatogram based on executing a peak-detection machine learning model, wherein the peak-detection machine learning model can be trained on a training dataset whose annotated chromatograms collectively exhibit a range of void dip sizes or locations. Training on such dataset can force the peak-detection machine learning model to more accurately learn how to distinguish void dips from chromatographic peaks which are hidden by, overlapping with, or disfigured by such void dips, such that the peak-detection machine learning model is robust or resistant to the problem of void interference. In some instances, such robustness or resistance to void interference can be reinforced by configuring the peak-detection machine learning model to receive as input not just chromatograms but also characteristic void locations that are empirically correlated with whatever individual chromatographs or other scientific instruments produced such chromatograms. In any case, the problem of void interference can be considered as being reduced.

Accordingly, the scientific instrument module 102 can facilitate void-based machine learning localization of chromatographic peaks.

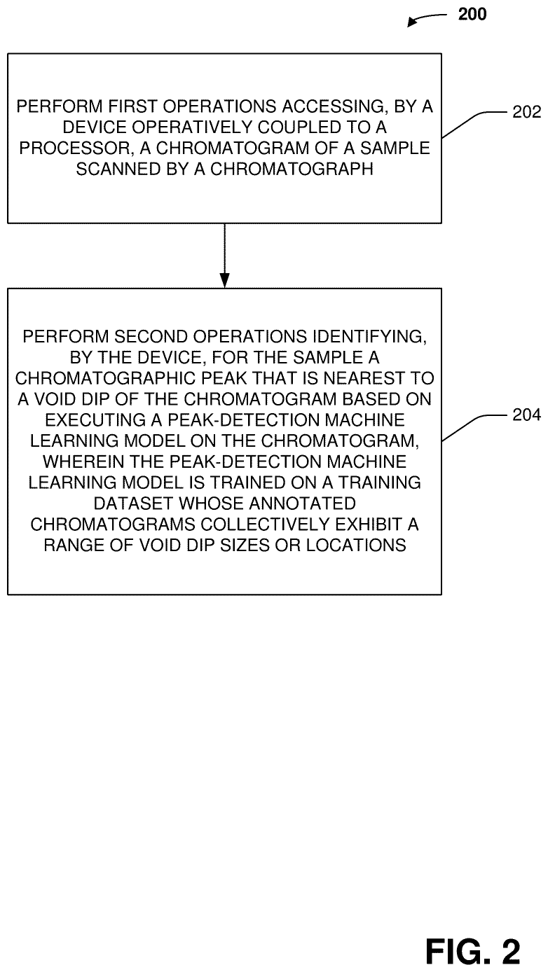

FIG. 2 is an example, non-limiting flow diagram of a computer-implemented method 200 in accordance with various embodiments described herein. The operations of the computer-implemented method 200 may be used in any suitable setting to perform any suitable operations (e.g., can be performed by or used in conjunction with any of the various modules, computing devices, or graphical user interfaces described with respect to FIGS. 1, 16, or 17). Operations are illustrated once each and in a particular order in FIG. 2, but the operations may be reordered or repeated as desired and appropriate (e.g., different operations performed may be performed in parallel, as suitable).

In various aspects, act 202 can include performing first operations accessing, by a device operatively coupled to a processor, a chromatogram of a sample scanned by a chromatograph. In various cases, the first logic 104 can perform or otherwise facilitate act 202.

In various instances, act 204 can include performing second operations identifying, by the device, for the sample a chromatographic peak that is nearest to a void dip of the chromatogram based on executing a peak-detection machine learning model on the chromatogram, wherein the peak-detection machine learning model is trained on a training dataset whose annotated chromatograms collectively exhibit a range of void dip sizes. In various cases, the second logic 106 can perform or otherwise facilitate act 204.

Accordingly, the computer-implemented method 200 can facilitate void-based machine learning localization of chromatographic peaks.

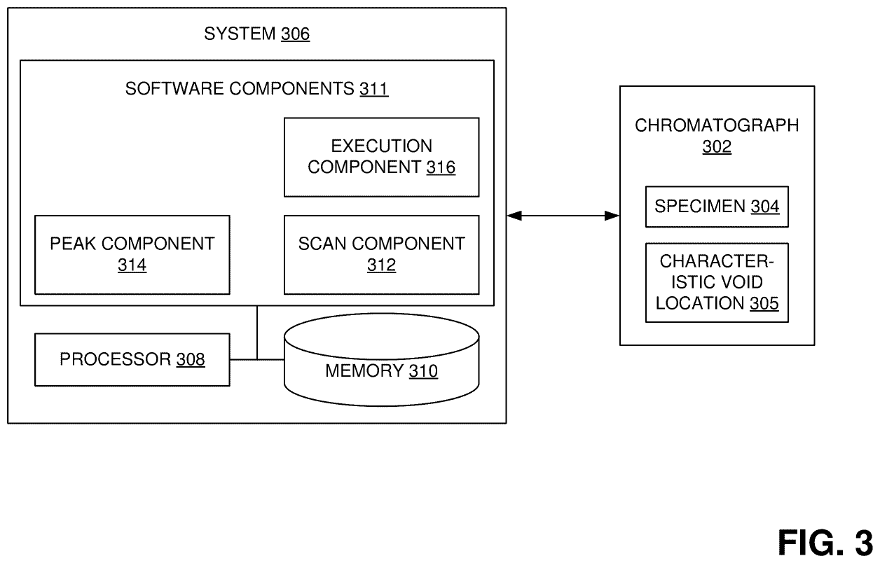

FIG. 3 illustrates a block diagram of an example, non-limiting system that can facilitate void-based machine learning localization of chromatographic peaks in accordance with one or more embodiments described herein.

In various embodiments, there can be a chromatograph 302. In various aspects, the chromatograph 302 can be any suitable chromatography device, such as a gas chromatograph, a liquid chromatograph, or an ion chromatograph. In various aspects, the chromatograph 302 can be made up of any suitable constituent hardware for separating an analytical sample into two or more compositional parts. As a non-limiting example, the constituent hardware can include an injector, an oven-heated column, and carrier fluid valves or pumps. In various aspects, the carrier fluid valves or pumps can cause carrier fluid (e.g., an inert gas, or a water-organic-solvent mixture) to flow through the chromatograph. In various instances, the injector can inject an analytical sample or specimen (e.g., a mixture or solution to be measured or analyzed) into the flowing carrier fluid. In various cases, the injected analytical sample or specimen can be carried by the flowing carrier fluid through the oven-heated column, which can contain any suitable absorbent packing material or stationary phase film. In various aspects, different compositional parts (e.g., different chemical elements, molecules, analytes, or species) of the analytical sample or specimen can interact differently or uniquely with the absorbent packing material or stationary phase film, thereby causing the different compositional parts of the analytical sample or specimen to have different flow rates through the oven-heated column. Due to such different flow rates, the different compositional parts can be considered as being physically separated from each other.

In various embodiments, the chromatograph 302 can be currently or presently loaded with a specimen 304. In other words, the specimen 304 can be physically within any suitable injector or autosampler of the chromatograph 302, such that the chromatograph 302 can be able to inject portions of the specimen 304 for analysis or scanning. In various aspects, the specimen 304 can be any suitable mixture, solution, or colloid for which chromatography analysis is desired. As a non-limiting example, the specimen 304 can be a food or beverage mixture, solution, or colloid. As another non-limiting example, the specimen 304 can be a pharmaceutical or medicinal mixture, solution, or colloid. As yet another non-limiting example, the specimen 304 can be a soil, water, air, scat, or other environmental mixture, solution, or colloid. In various instances, the specimen 304 can have or exhibit any suitable stability or shelf-life. Indeed, in some cases, the specimen 304 can be a stable mixture, solution, or colloid that has a shelf-life of days, weeks, months, or even years. In other cases, the specimen 304 can instead be an unstable mixture, solution, or colloid that has a shelf-life of mere hours or minutes.

In various aspects, the chromatograph 302 can be associated with a characteristic void location 305. Indeed, the chromatograph 302 can, in response to scanning any given sample, produce a chromatogram for that given sample. Due to the passage of unretained or weakly retained chemical species (e.g., water) through the oven-heated column of the chromatograph 302, each chromatogram produced by the chromatograph 302 can contain a void dip. In various cases, the size (e.g., height or width) of the void dip can vary with selectively configurable operational parameters of the chromatograph 302. That is, setting the operational parameters (e.g., eluent flow rate, column temperature, column chemistry, injection style) of the chromatograph 302 to different combinations of values or states can cause the void dip to be taller, shorter, thinner, or fatter. In contrast, the location of the void dip (e.g., the retention times at which the void dip occurs) can be relatively constant with respect to the operational parameters of the chromatograph 302 (although it can nevertheless uniquely correspond to the chromatograph 302). In other words, non-configurable aspects (e.g., such as conduit or column size) of the chromatograph 302 can dictate when the void dip occurs during a scan, whereas selectively configurable operational parameters of the chromatograph 302 can have little to no effect on such timing of the void dip. Accordingly, the chromatograph 302 can be considered as frequently, usually, or otherwise normally detecting void dips during a particular retention time interval, and that particular retention time interval can be referred to as the characteristic void location 305. For instance, the characteristic void location 305 can be denoted [A, B] for any suitable positive retention times A<B. This can be interpreted to mean that void dips detected by the chromatograph 302 are expected to begin or start (e.g., to spike sharply from or near an intensity value of zero toward negative intensity values) at or after the retention time A and are expected to end or terminate (e.g., to return from such negative intensity values back to an intensity value at or near zero) at or before the retention time B. In some cases, the characteristic void location 305 can be determined empirically.

As a non-limiting example, the chromatograph 302 can perform a plurality of scans on any suitable number of specimens or samples, thereby yielding a plurality of chromatograms, each of which can depict a void dip having a respective starting retention time (e.g., which can be identified as the time at which the intensity signal in a given chromatogram passes beyond a threshold margin below zero) and a respective ending retention time (e.g., which can be identified as the time at which the intensity signal in the given chromatogram returns back to being within that threshold margin of zero). In such case, A can be equal to the average of all the starting times of the void dips depicted in that plurality of chromatograms, and B can be equal to the average of all the ending times of the void dips depicted in that plurality of chromatograms.

Although not explicitly shown in FIG. 3, it should be understood or otherwise appreciated that the chromatograph 302 can be coupled upstream of any suitable mass spectrometer, such that chemical species that elute from the chromatograph 302 can be subsequently scanned in order of elution by the mass spectrometer. In such situation, each time-intensity tuple of any chromatogram produced by the chromatograph 302 can have a respective mass spectrum produced by the mass spectrometer.

In any case, it can be desired to perform chromatographic peak localization with respect to the specimen 304. As described herein, a system 306 can facilitate or otherwise accomplish such objective.

In various aspects, the system 306 can comprise a processor 308 (e.g., computer processing unit, microprocessor) and a non-transitory computer-readable memory 310 that is operably or operatively or communicatively connected or coupled to the processor 308. The non-transitory computer-readable memory 310 can store computer-executable instructions which, upon execution by the processor 308, can cause the processor 308 or other components of the system 306 (e.g., scan component 312, peak component 314, execution component 316) to perform one or more acts. In various embodiments, the non-transitory computer-readable memory 310 can store computer-executable components (e.g., scan component 312, peak component 314, execution component 316), and the processor 308 can execute the computer-executable components.

In various embodiments, the system 306 can be electronically coupled or integrated to or with the chromatograph 302 via any suitable wired or wireless electronic connection. So, the system 306 can electronically access the chromatograph 302. That is, the system 306 can electronically communicate or otherwise electronically interact with (e.g., transmit electronic instructions or commands to, receive electronic data from) the chromatograph 302. Accordingly, any component of the system 306 can interact with, communicate with, or otherwise manipulate the chromatograph 302.

In various embodiments, the system 306 can comprise a scan component 312. In various aspects, the scan component 312 can, as described herein, cause the chromatograph 302 to generate a chromatogram for the specimen 304.

In various embodiments, the system 306 can comprise a peak component 314. In various instances, the peak component 314 can, as described herein and via a peak-detection machine learning model, localize a near-void peak within the chromatogram produced for the specimen 304.

In various embodiments, the system 306 can comprise an execution component 316. In various cases, the execution component 316 can, as described herein, perform any suitable transmission, rendition, or integration actions with respect to the near-void peak localized in the chromatogram of the specimen 304.

Note that, in various instances, the scan component 312, the peak component 314, and the execution component 316 can collectively be considered as being one or more software components 311 of the system 306. In various aspects, it should be appreciated that the one or more software components 311 are described primarily herein as comprising three components (e.g., the scan component 312, the peak component 314, and the execution component 316) for ease of explanation and illustration. However, the one or more software components 311 are not limited to being implemented as exactly such three components in every embodiment. Indeed, in some embodiments, the functionalities described herein of such three components can be combined in any suitable fashions, so as to be implemented in or by fewer than three components (e.g., in some cases, a single component can perform all of the functionalities that are described herein with respect to the scan component 312, the peak component 314, and the execution component 316). In other embodiments, the functionalities described herein of such three components can instead be distributed, separated, split, or fragmented in any suitable fashions, so as to be implemented in or by more than three components (e.g., two or more components can facilitate the functionalities that are performable by the scan component 312; two or more components can facilitate the functionalities that are performable by the peak component 314; two or more components can facilitate the functionalities that are performable by the execution component 316).

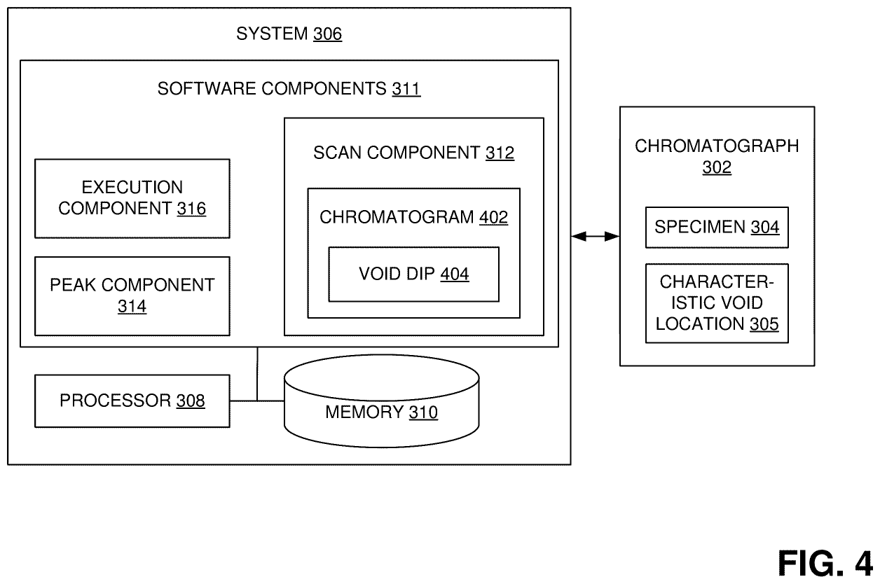

FIG. 4 illustrates a block diagram of an example, non-limiting system including a chromatogram depicting a void dip that can facilitate void-based machine learning localization of chromatographic peaks in accordance with one or more embodiments described herein.

In various embodiments, the scan component 312 can electronically instruct, electronically command, or otherwise electronically cause the chromatograph 302 to scan the specimen 304 according to any suitable chromatography scanning protocol. For instance, the chromatograph 302 can perform on the specimen 304 a scan in which the selectively configurable operating parameters of the chromatograph 302 are set to any suitable default or user-specified values or states. As a non-limiting example, such scan can involve any suitable default eluent or any other eluent that is chosen by a user. As another non-limiting example, such scan can involve any suitable default eluent flow rate or any other eluent flow rate that is chosen by a user. As yet another non-limiting example, such scan can involve any suitable default sample injection amount (e.g., split versus splitless) or any other sample injection amount that is chosen by a user. As still another non-limiting example, such scan can involve any suitable default oven-heated column temperature ramping or temperature programming or any other oven-heated column temperature ramping or temperature programming that is chosen by a user. As another non-limiting example, such scan can involve any suitable default isocratic elution process or any other isocratic elution process chosen by a user. As even another non-limiting example, such scan can involve any suitable default gradient elution process or any other gradient elution process chosen by a user.

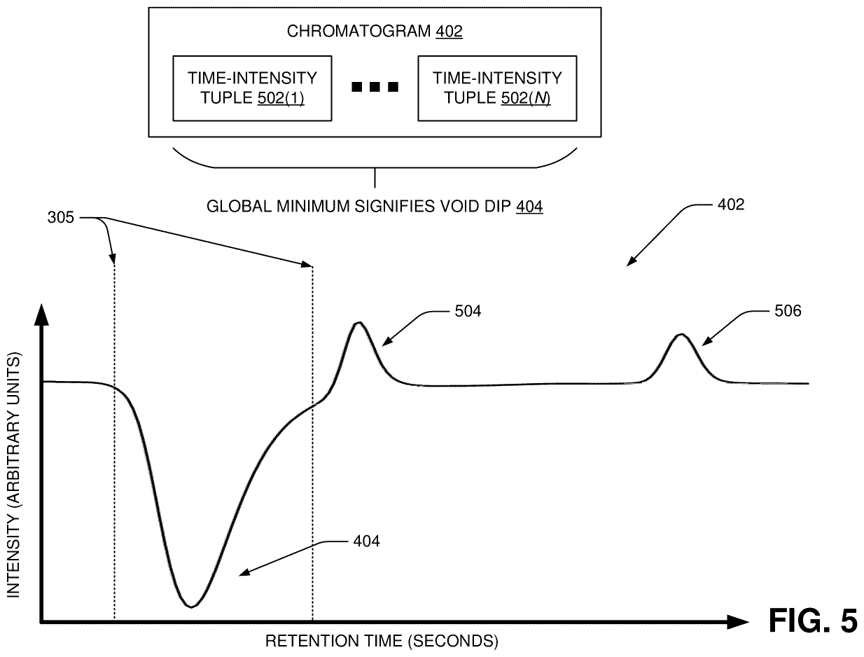

No matter what scanning protocol is implemented, such scanning can cause the chromatograph 302 to produce a chromatogram 402. In various instances, the chromatogram 402 can be a graph or plot of intensity versus retention time for the specimen 304. In various cases, the chromatogram 402 can depict, illustrate, or otherwise contain a void dip 404. Non-limiting aspects are described with respect to FIG. 5.

FIG. 5 illustrates an example, non-limiting block diagram and pictorial illustration of the chromatogram 402 depicting the void dip 404 in accordance with one or more embodiments described herein.

First, consider the upper, block-diagram portion of FIG. 5. In various aspects, the chromatogram 402 can include a total of n tuples, for any suitable positive integer n: a time-intensity tuple 502(1) to a time-intensity tuple 502(n). In various cases, each of those time-intensity tuples can be a two-element vector, the first element of which can be a scalar that indicates a respective retention time, and the second element of which can be a scalar that indicates how much intensity or concentration was measured by a chromatographic detector of the chromatograph 302 at that respective retention time. As a non-limiting example, the time-intensity tuple 502(1) can be a vector indicating a first retention time and a first intensity value that was measured at that first retention time. As another non-limiting example, the time-intensity tuple 502(n) can be a vector indicating an n-th retention time and an n-th intensity value that was measured at that n-th retention time. In various aspects, it can be the case that no two of those n time-intensity tuples have the same retention time as each other. Moreover, in various instances, it can be the case that those n time-intensity tuples are ordered chronologically from lowest retention time to highest retention time. Accordingly, the chromatogram 402 can be considered as a timeseries of intensities that are measured by the chromatograph 302 during the scan of the specimen 304. In various cases, any contiguous subset, string, or chain of the plurality of time-intensity tuples 502 which contain a global minimum intensity of the chromatogram 402 can be considered as being or forming the void dip 404.

Next, consider the lower, pictorial-illustration portion of FIG. 5. In various aspects, as shown, the chromatogram 402 can be considered as a plot, graph, or chart whose abscissa axis represent retention time (e.g., measured in seconds) and whose ordinate axis represents detector intensity (e.g., measured in arbitrary units). In the non-limiting example of FIG. 5, the chromatogram 402 depicts a total of two chromatographic peaks: a peak 504, and a peak 506. However, it should be appreciated that the chromatogram 402 can depict any other suitable number of peaks, each having any suitable size (e.g., height, width) or location (e.g., occurring at any suitable retention time). In various cases, the void dip 404 can occur before or earlier than all peaks of the chromatogram 402 (e.g., note how the void dip 404 is leftward of the peak 504 and the peak 506). In various aspects, FIG. 5 shows the characteristic void location 305 via two vertical dotted lines (e.g., the left-most vertical dotted line can be considered as representing the retention time A above, and the right-most vertical dotted line can be considered as representing the retention time B above). Accordingly, no matter the operational parameter configuration of the chromatograph 302, a void dip detected by the chromatograph 302 can usually, normally, or frequently be expected to fall somewhere in between those two vertical dotted lines. However, as mentioned above, the height or width (e.g., tail heaviness or thickness) of any given void dip can vary depending upon the specific operational parameter configuration of the chromatograph 302. As a non-limiting example, changing the eluent flow rate of the chromatograph 302 can cause the void dip 404 to become shorter or taller but to nevertheless still be located in between the two vertical dotted lines. As another non-limiting example, changing the column temperature ramping of the chromatograph 302 can cause the void dip 404 to become fatter or skinnier but to nevertheless still be located in between the two vertical dotted lines.

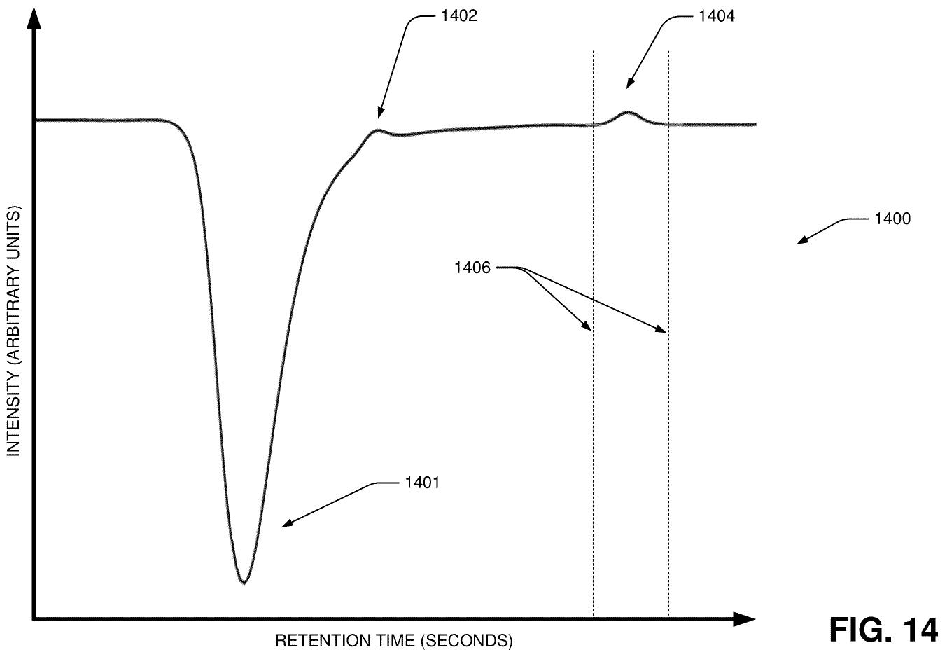

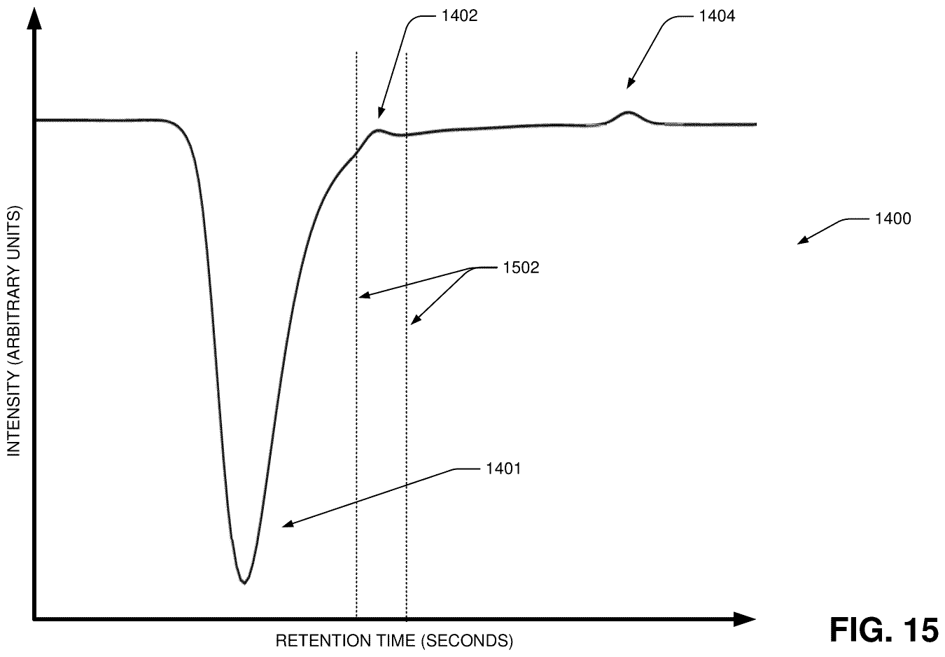

Note how the peak 504 is closer in time to the void dip 404 than the peak 506 is. Because of this temporal closeness or proximity, a likelihood of incorrectly or unreliably localizing the peak 504 can be increased. For instance, the peak 504 can be considered as being at least partially overlapping with, hidden by, or otherwise disfigured by the tail end of the void dip 404, and such overlap, hiding, or disfigurement can throw off or confuse peak localization algorithms. As a non-limiting example, in situations where the height of the peak 504 is commensurate or on the same order of magnitude of that of the void dip 404 (e.g., such as is shown in FIG. 5), such algorithms can be less likely to miss or ignore the peak 504 altogether but can be more likely to grossly underestimate the starting retention time or overestimate the stopping retention time of the peak 504. As another non-limiting example, in situations where the height of the peak 504 is not commensurate or is one or more orders of magnitude smaller than that of the void dip 404 (e.g., not shown in FIG. 5, but an example is shown in FIGS. 14-15), such algorithms can be more likely to completely miss or ignore the peak 504 altogether. For at least these reasons, the void dip 404 can be considered as interfering with localization of the peak 504.

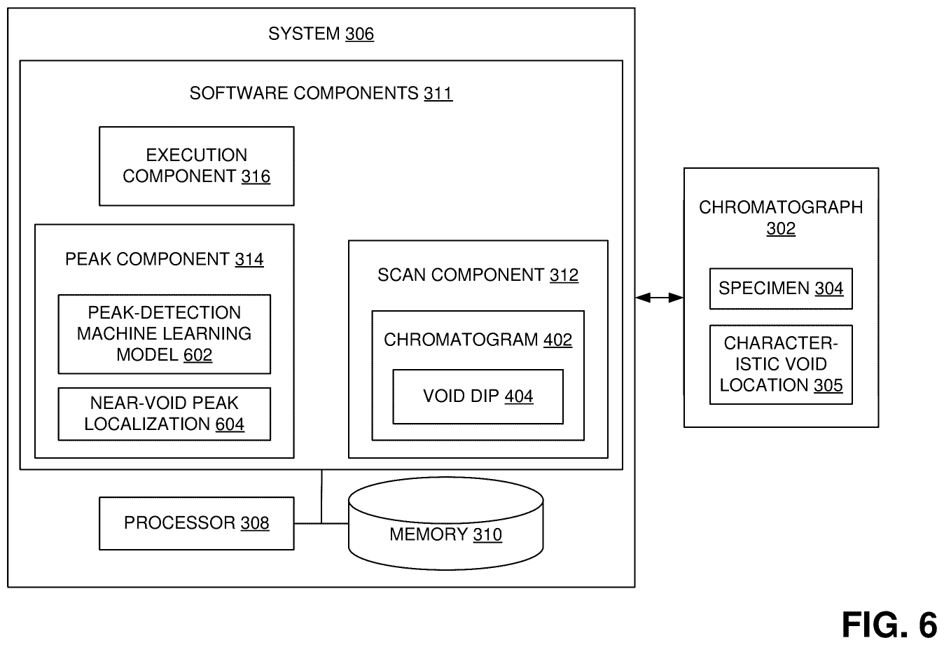

FIG. 6 illustrates a block diagram of an example, non-limiting system including a peak-detection machine learning model and a near-void peak that can facilitate void-based machine learning localization of chromatographic peaks in accordance with one or more embodiments described herein.

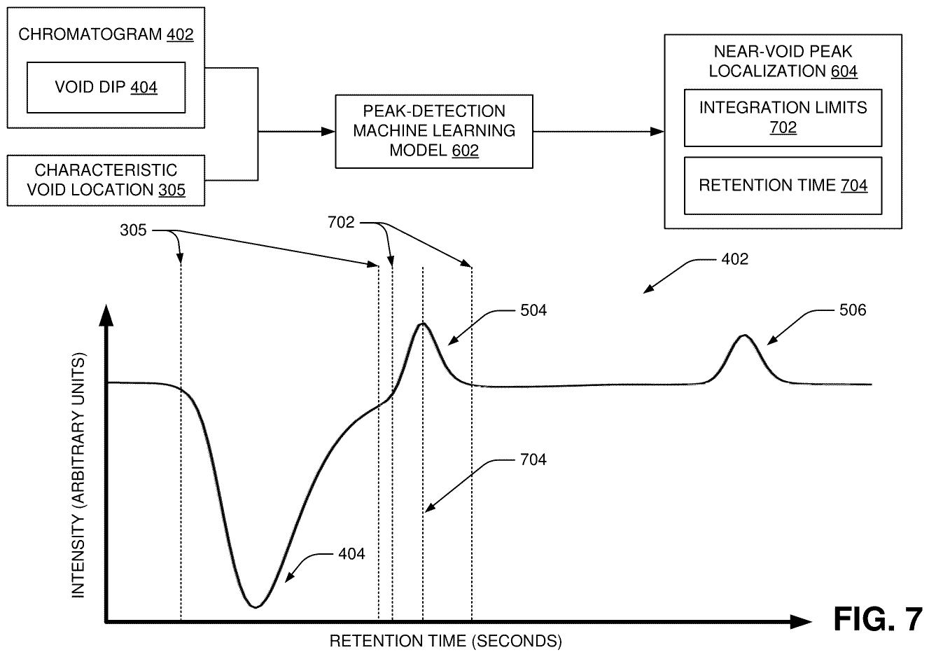

In various embodiments, the peak component 314 can electronically store, electronically maintain, electronically control, or otherwise electronically access a peak-detection machine learning model 602. In various instances, the peak component 314 can leverage the peak-detection machine learning model 602, so as to generate a near-void peak localization 604 based on the chromatogram 402. Various non-limiting aspects are described with respect to FIG. 7.

FIG. 7 illustrates an example, non-limiting block diagram and pictorial illustration showing how the near-void peak localization 604 can be obtained via the peak-detection machine learning model 602 in accordance with one or more embodiments described herein.

First, consider the upper, block-diagram portion of FIG. 7. In various embodiments, the peak-detection machine learning model 602 can exhibit any suitable type, style, construction, or design of internal architecture. For instance, the peak-detection machine learning model 602 can exhibit any suitable deep learning internal architecture.

Indeed, in various cases, the peak-detection machine learning model 602 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

However, this is merely a non-limiting example. In various embodiments, the peak-detection machine learning model 602 can exhibit any other suitable type of artificial intelligence architecture. As a non-limiting example, the peak-detection machine learning model 602 can exhibit any suitable type of support vector machine architecture. As another non-limiting example, the peak-detection machine learning model 602 can exhibit any suitable type of naïve Bayes architecture. As yet another non-limiting example, the peak-detection machine learning model 602 can exhibit any suitable type of linear regression architecture. As still another non-limiting example, the peak-detection machine learning model 602 can exhibit any suitable type of logistic regression architecture. As even another non-limiting example, the peak-detection machine learning model 602 can exhibit any suitable type of decision tree or random forest architecture. As another non-limiting example, the peak-detection machine learning model 602 can exhibit any suitable combination of any of the above-mentioned architectures.

Regardless of the specific internal architecture (e.g., the specific numbers, types, or organizations of layers) that is implemented within the peak-detection machine learning model 602, the peak-detection machine learning model 602 can be configured as a segmenter or regressor that determines, in response to being executed on inputted chromatograms, the locations of whichever chromatographic peaks in those inputted chromatograms are temporally nearest or closest to void dips exhibited by those inputted chromatograms. Accordingly, the peak component 314 can, in various aspects, electronically execute the peak-detection machine learning model 602 on the chromatogram 402, and such execution can yield the near-void peak localization 604.

As a non-limiting example, suppose that the peak-detection machine learning model 602 has a deep learning internal architecture. In some of such cases, the peak component 314 can feed the chromatogram 402 to the input layer of the peak-detection machine learning model 602, the chromatogram 402 can complete a forward pass through the one or more hidden layers of the peak-detection machine learning model 602, and the output layer of the peak-detection machine learning model 602 can calculate or compute the near-void peak localization 604 based on whatever activation maps or features maps are produced by the one or more hidden layers during that forward pass. In others of such cases, the peak component 314 can concatenate the chromatogram 402 and the characteristic void location 305 together and can feed that concatenation to the input layer of the peak-detection machine learning model 602. Such concatenation can complete a forward pass through the one or more hidden layers of the peak-detection machine learning model 602, and the output layer of the peak-detection machine learning model 602 can calculate or compute the near-void peak localization 604 based on whatever activation maps or features maps are produced by the one or more hidden layers during that forward pass.

Note that the near-void peak localization 604 can be accurately or confidently generated in situations where the peak-detection machine learning model 602 is not configured to receive the characteristic void location 305 as a supplemental or complementary input argument in conjunction with the chromatogram 402, due to how the peak-detection machine learning model 602 is trained as described later herein. However, such accuracy or confidence can be even further increased in situations where the peak-detection machine learning model 602 is configured to receive the characteristic void location 305 as a supplemental or complementary input argument in conjunction with the chromatogram 402. Indeed, by treating the characteristic void location 305 as an explicit supplemental or complementary input argument, the peak-detection machine learning model 602 can be forced to pay extra attention to whichever portion of the chromatogram 402 corresponds to (e.g., occurs within the retention time interval defined by) the characteristic void location 305.

In any case, the near-void peak localization 604 can be electronic data exhibiting any suitable format, size, or dimensionality (e.g., can be one or more scalars, one or more vectors, one or more matrices, one or more tensors, one or more character strings, or any suitable combination thereof) that indicates, specifies, or otherwise represents where within the chromatogram 402 a chromatographic peak that is temporally nearest or closest to the void dip 404 is located or positioned, hence the term “near-void.” In various aspects, the near-void peak localization 604 can include integration limits 702 or a retention time 704. In various instances, the integration limits 702 can be made up of two positive scalars, one scalar representing a retention time at which the peak-detection machine learning model 602 believes that whatever chromatographic peak that is nearest or closest to the void dip 404 begins or starts (e.g., the predicted or inferred moment or instant at which the detected intensity signal spikes above zero to form that peak), and another scalar representing a retention time at which that nearest or closest chromatographic peak ends or terminates (e.g., the predicted or inferred moment or instant at which the detected intensity signal that spiked upward to form that peak returns back to zero). Note that the term “integration limits” can be appropriate, since it can be desired to compute an area-under-curve for, thereby integrating, whatever chromatographic peak that is nearest or closest to the void dip 404, and since such integrating can begin at whichever retention time at which such peak begins and can end at whichever retention time at which such peak ends. In various aspects, the retention time 704 can be a positive scalar representing the specific or particular instant or moment at which the maximum or highest intensity value of that nearest or closest chromatographic peak occurred.

For non-limiting clarification, consider the lower, pictorial-illustration portion of FIG. 7. As previously described, the chromatogram 402 can be considered as a graph, chart, or plot of intensity versus retention time, where the void dip 404 can occur before or earlier than both the peak 504 and the peak 506. As explained above, the peak 504 can be temporally nearer or closer to the void dip 404 than the peak 506 is to the void dip 404. Accordingly, the peak 504 can, in this non-limiting example, be considered as the chromatographic peak that is nearest or closest to the void dip 404. As shown, the retention time 704 is indicated by a vertical dotted line that denotes the single or individual retention time at which the peak 504 reaches (in the opinion of the peak-detection machine learning model 602) its apex or maximum value. In contrast, the integration limits 702 are indicated by two vertical dotted lines, the left-most of which denotes a single or individual retention time at which the peak 504 first departs from zero (in the opinion of the peak-detection machine learning model 602), and the right-most of which denotes a single or individual retention time at which the peak 504 returns back to zero (in the opinion of the peak-detection machine learning model 602).

In various embodiments, the execution component 316 of the computerized tool can electronically perform any suitable actions based on the near-void peak localization 604. As a non-limiting example, the execution component 316 can electronically transmit or share the near-void peak localization 604 to or with any other suitable computing device. As another non-limiting example, the execution component 316 can electronically render the near-void peak localization 604 or any graphical depiction thereof on any suitable computer screen, monitor, or display device (e.g., on the screen of a computerized workstation associated with the chromatograph 302). As even another non-limiting example, the execution component 316 can integrate the chromatogram 402 between the integration limits 702, thereby yielding an area-under-curve value for whatever portion of the chromatogram 402 that falls within or is demarcated by the near-void peak localization 604 (e.g., the area beneath the peak 504 but above an intensity of zero), and the execution component 316 can transmit, share, or render such area-under-curve value in any suitable fashion. As yet another non-limiting example, in situations where the chromatograph 302 is upstream of a mass spectrometer, the execution component 316 can perform any suitable mass spectrometry analyses (e.g., characteristic peak matching) on whatever mass spectra that the mass spectrometer has produced for the time-intensity tuples of the chromatogram 402 that fall within or are otherwise demarcated by the near-void peak localization 604.

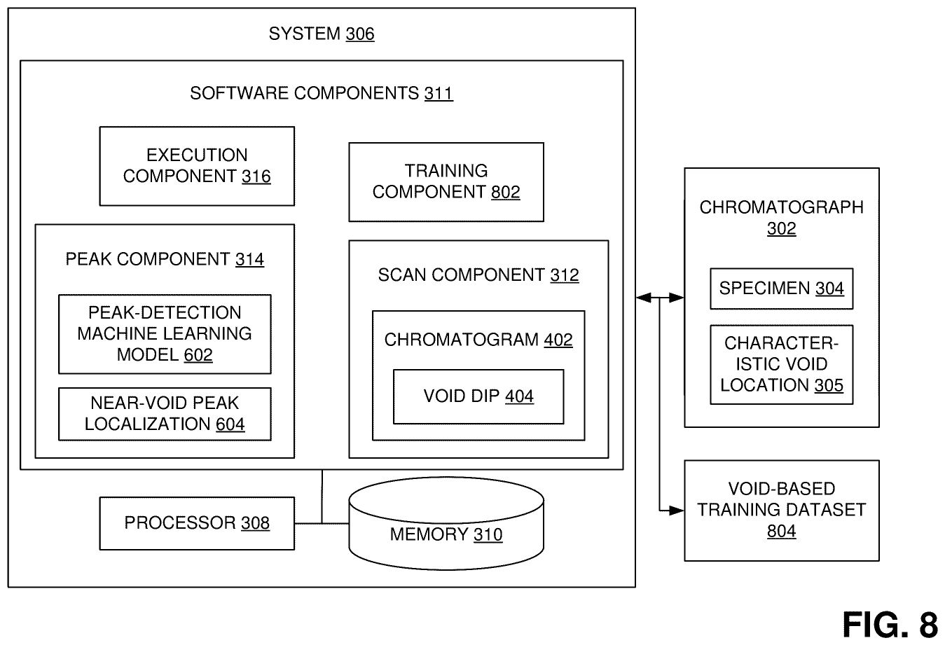

In order for the peak-detection machine learning model 602 to function correctly, the peak-detection machine learning model 602 can first undergo training. A non-limiting example of such training is described with respect to FIGS. 8-11.

FIG. 8 illustrates a block diagram of an example, non-limiting system including a training component and a void-based training dataset that can facilitate void-based machine learning localization of chromatographic peaks in accordance with one or more embodiments described herein.

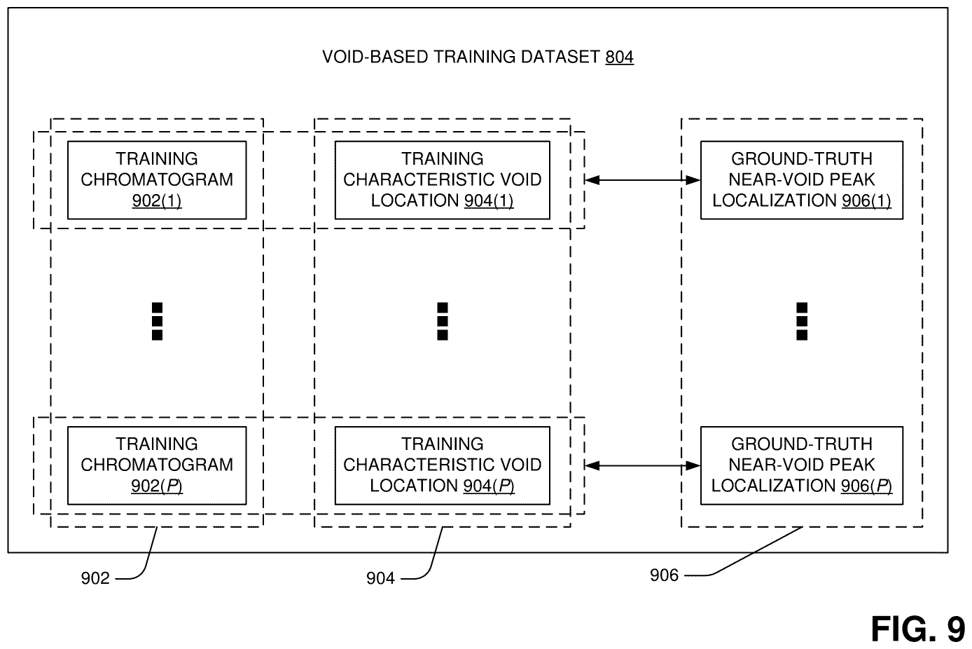

In various embodiments, the one or more software components 311 can comprise a training component 802. In various aspects, the training component 802 can electronically train the peak-detection machine learning model 602 by leveraging a void-based training dataset 804. Non-limiting aspects are described with respect to FIGS. 9-11.

FIG. 9 illustrates an example, non-limiting block diagram of the void-based training dataset 804 in accordance with one or more embodiments described herein.

In various embodiments, the void-based training dataset 804 can include a plurality of training chromatograms 902. In various aspects, the plurality of training chromatograms 902 can have a total of p chromatograms, for any suitable positive integer p: a training chromatogram 902(1) to a training chromatogram 902(p). In various instances, each of the plurality of training chromatograms 902 can be a distinct or respective chromatogram that was produced by any suitable chromatograph (e.g., not necessarily the chromatograph 302) for any suitable specimen (e.g., not necessarily the specimen 304) and that contains or exhibits a respective void dip. In various cases, the plurality of training chromatograms 902 can span or otherwise be representative of a varied or diverse range or spectrum of void dip sizes or void dip locations. As a non-limiting example, the plurality of training chromatograms 902 can contain void dips whose collective heights exhibit more than any suitable threshold amount of variance or standard deviation. As another non-limiting example, the plurality of training chromatograms 902 can contain void dips whose collective widths (e.g., whose tail heaviness or full-width-at-half-maximum values) exhibit more than any suitable threshold amount of variance or standard deviation. As even another non-limiting example, the plurality of training chromatograms 902 can contain void dips whose collective starting retention times exhibit more than any suitable threshold amount of variance or standard deviation. As yet another non-limiting example, the plurality of training chromatograms 902 can contain void dips whose collective ending retention times exhibit more than any suitable threshold amount of variance or standard deviation.

In situations where the peak-detection machine learning model 602 is configured to receive characteristic void location as a supplemental input argument, the void-based training dataset 804 can include a plurality of training characteristic void locations 904. In various aspects, the plurality of training characteristic void locations 904 can respectively correspond (e.g., in one-to-one fashion) with the plurality of training chromatograms 902. Since the plurality of training chromatograms 902 can include p chromatograms, the plurality of training characteristic void locations 904 can likewise contain p locations: a training characteristic void location 904(1) to a training characteristic void location 904(p). In various instances, each of the plurality of training characteristic void locations 904 can have the same format, size, or dimensionality as the characteristic void location 305 and can indicate, specify, or otherwise convey a retention time interval within which whatever chromatograph that generated a respective one of the plurality of training chromatograms 902 is expected to detect void dips. As a non-limiting example, the training characteristic void location 904(1) can correspond to the training chromatogram 902(1). So, the training characteristic void location 904(1) can specify a retention time interval during which whatever chromatograph that generated the training chromatogram 902(1) is expected to detect void dips. As another non-limiting example, the training characteristic void location 904(p) can correspond to the training chromatogram 902(p). Thus, the training characteristic void location 904(p) can specify a retention time interval during which whatever chromatograph that generated the training chromatogram 902(p) is expected to detect void dips.

In situations where the peak-detection machine learning model 602 is not configured to receive characteristic void location as a supplemental input argument, the plurality of training characteristic void locations 904 can be omitted.

In any case, the void-based training dataset 804 can include a plurality of ground-truth near-void peak localizations 906. In various aspects, the plurality of ground-truth near-void peak localizations 906 can respectively correspond (e.g., in one-to-one fashion) to the plurality of training chromatograms 902. So, the plurality of ground-truth near-void peak localizations 906 can have p localizations: a ground-truth near-void peak localization 906(1) to a ground-truth near-void peak localization 906(p). In various instances, each of the plurality of ground-truth near-void peak localizations 906 can be considered as a correct or accurate localization of whatever chromatographic peak that is known or deemed to be nearest or closest to the void dip of a respective one of the plurality of training chromatograms 902. As a non-limiting example, the ground-truth near-void peak localization 906(1) can correspond to the training chromatogram 902(1). Thus, the ground-truth near-void peak localization 906(1) can have the same size, format, or dimensionality as the near-void peak localization 604 and can indicate, specify, or otherwise represent the correct or accurate location or position of (e.g., the correct or accurate integration limits or apex retention time of) the void dip that is known or deemed to be depicted in the training chromatogram 902(1). As another non-limiting example, the ground-truth near-void peak localization 906(p) can correspond to the training chromatogram 902(p). So, the ground-truth near-void peak localization 906(p) can have the same size, format, or dimensionality as the near-void peak localization 604 and can indicate, specify, or otherwise represent the correct or accurate location or position of (e.g., the correct or accurate integration limits or apex retention time of) the void dip that is known or deemed to be depicted in the training chromatogram 902(p).

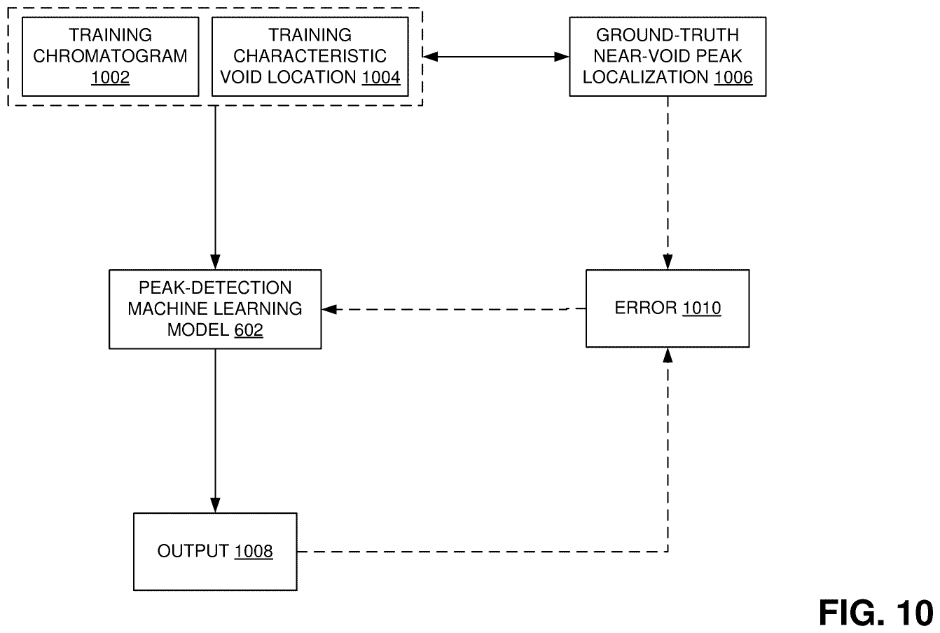

FIG. 10 illustrates an example, non-limiting block diagram showing how the peak-detection machine learning model 602 can be trained in accordance with one or more embodiments described herein.

In various aspects, prior to beginning training, the trainable internal parameters (e.g., convolutional kernels, weight matrices, bias values) of the peak-detection machine learning model 602 can be initialized in any suitable fashion (e.g., via random initialization) by the training component 802.

In various embodiments, the training component 802 can select any suitable training chromatogram, which may or may not be accompanied by a training characteristic void location depending upon how the peak-detection machine learning model 602 is configured, and corresponding ground-truth near-void peak localization from the void-based training dataset 804. These can respectively be referred to as a training chromatogram 1002, a training characteristic void location 1004, and a ground-truth near-void peak localization 1006.

In various aspects, the training component 802 can cause the peak-detection machine learning model 602 to be executed on the training chromatogram 1002 (and on the training characteristic void location 1004, as appropriate), thereby causing the peak-detection machine learning model 602 to produce an output 1008. As a non-limiting example, in situations where the peak-detection machine learning model 602 is configured to receive characteristic void location as a supplemental input, the training chromatogram 1002 and the training characteristic void location 1004 can be concatenated together, such concatenation can be fed or routed to the input layer of the peak-detection machine learning model 602, such concatenation can complete a forward pass through the one or more hidden layers of the peak-detection machine learning model 602, and the output layer of the peak-detection machine learning model 602 can compute the output 1008 based on activation maps or feature maps provided by the one or more hidden layers during such forward pass. As another non-limiting example, in situations where the peak-detection machine learning model 602 is not configured to receive characteristic void location as a supplemental input, the training chromatogram 1002 can be fed or routed by itself to the input layer of the peak-detection machine learning model 602, the training chromatogram 1002 can complete a forward pass through the one or more hidden layers of the peak-detection machine learning model 602, and the output layer of the peak-detection machine learning model 602 can compute the output 1008 based on activation maps or feature maps provided by the one or more hidden layers during such forward pass.

Note that the format, size, or dimensionality of the output 1008 can be dictated by the number, arrangement, sizes, or other characteristics of the neurons, convolutional kernels, attention blocks, or other internal parameters of the output layer (or of any other layers) of the peak-detection machine learning model 602. Accordingly, the output 1008 can be forced to have any desired format, size, or dimensionality, by adding, removing, or otherwise adjusting characteristics of the output layer (or of any other layers) of the peak-detection machine learning model 602.

In various aspects, the output 1008 can be forced to have the same format, size, or dimensionality as the ground-truth near-void peak localization 1006. Thus, the output 1008 can be considered as the predicted or inferred near-void localization that the peak-detection machine learning model 602 has created for the training chromatogram 1002. In contrast, the ground-truth near-void peak localization 1006 can be considered as whatever correct or accurate near-void peak localization that is known or deemed to correspond to the training chromatogram 1002. Note that, if the peak-detection machine learning model 602 has so far undergone no or little training, then the output 1008 can be highly inaccurate. In other words, the output 1008 can be very different from the ground-truth near-void peak localization 1006.

In various aspects, an error 1010 (e.g., mean absolute error, mean squared error, cross-entropy error) between the output 1008 and the ground-truth near-void peak localization 1006 can be computed by the training component 802. In various instances, the training component 802 can incrementally update the trainable internal parameters of the peak-detection machine learning model 602 via backpropagation (e.g., stochastic gradient descent) based on the error 1010.

In various cases, such execution-and-update procedure can be repeated for any suitable number of training chromatograms (e.g., for each training chromatogram in the void-based training dataset 804). This can ultimately cause the trainable internal parameters of the peak-detection machine learning model 602 to become iteratively optimized for accurately localizing peaks that are near or close to void dips depicted in inputted chromatograms. In various aspects, any suitable training batch sizes, any suitable error/loss functions, or any suitable training termination criteria can be utilized during such training.

Although the herein disclosure mainly describes the peak-detection machine learning model 602 as being trained in supervised fashion, this is a mere non-limiting example for ease of explanation and illustration. In various embodiments, any other suitable training paradigms can be used to train the peak-detection machine learning model 602, such as unsupervised training, semi-supervised training, or reinforcement learning, any of which may be federated or unfederated.

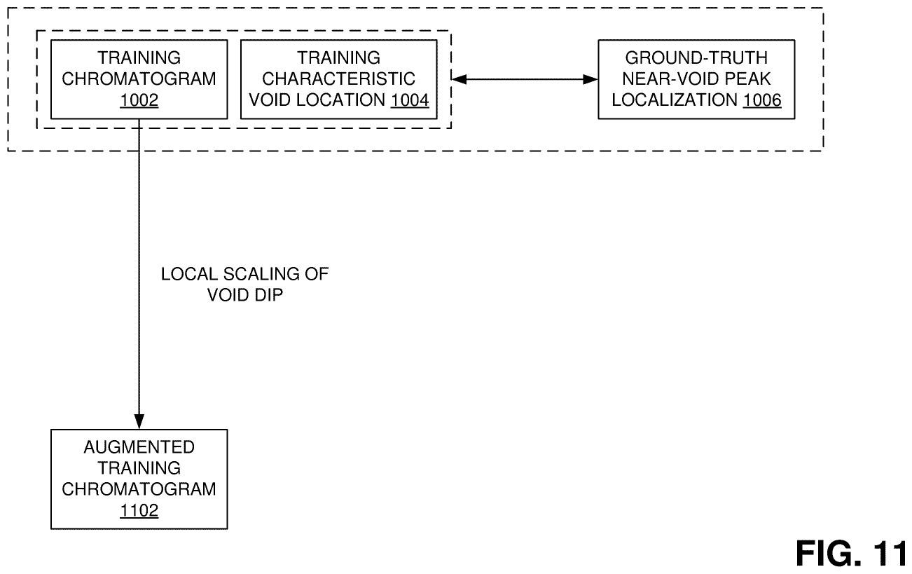

As explained above, the peak-detection machine learning model 602 can be made robust or resilient against void interference, by causing the plurality of training chromatograms 902 to span or be representative of a varied or diverse range of void dip sizes or void dip locations. In some instances, this diversity or representativeness can be accomplished via curation of the void-based training dataset 804 (e.g., by purposely including in the void-based training dataset 804 chromatograms that depict very different void dips). But in other instances, this diversity or representativeness can be accomplished via void dip augmentation, such as described with respect to FIG. 11.

FIG. 11 illustrates an example, non-limiting block diagram showing how the void-based training dataset 804 can be augmented or expanded in accordance with one or more embodiments described herein.

Consider again the training chromatogram 1002, the training characteristic void location 1004, and the ground-truth near-void peak localization 1006. In various aspects, the training chromatogram 1002 can depict a particularly-sized or particularly-shaped void dip. In various instances, the training component 802 can increase the size of the void-based training dataset 804, by converting the training chromatogram 1002 into an augmented training chromatogram 1102 to which the training characteristic void location 1004 and the ground-truth near-void peak localization 1006 still apply.

In particular, the training component 802 can create a copy of the training chromatogram 1002. That copy can be considered as being the same sequence of time-intensity tuples as the training chromatogram 1002 and can thus depict the same void dip as the training chromatogram 1002.

In some instances, the training component 802 can locally vertically scale the void dip that is within that copy of the training chromatogram 1002. That is, the training component 802 can multiply by any suitable scaling factor whatever intensity values of that copy that correspond to retention times falling within the training characteristic void location 1004. If the scaling factor is greater than one, this can cause the intensity values of that copy that correspond to retention times falling within the training characteristic void location 1004 to be respectively greater than the intensity values of the training chromatogram 1002 that correspond to retention times falling within the training characteristic void location 1004. So, the void dip of that copy can be considered as being heightened, while all other portions of that copy (e.g., all intensity values corresponding to retention times that are outside of the training characteristic void location 1004) can be unchanged (e.g., can be identical to those in the training chromatogram 1002). In contrast, if the scaling factor is less than one, this can cause the intensity values of that copy that correspond to retention times falling within the training characteristic void location 1004 to be respectively lesser than the intensity values of the training chromatogram 1002 that correspond to retention times falling within the training characteristic void location 1004. Thus, the void dip of that copy can be considered as being shortened, while all other portions of that copy (e.g., all intensity values corresponding to retention times that are outside of the training characteristic void location 1004) can be unchanged (e.g., can be identical to those in the training chromatogram 1002).

In other instances, the training component 802 can locally horizontally scale the void dip that is within that copy of the training chromatogram 1002. In particular, the training characteristic void location 1004 can be considered as demarcating a sub-sequence of time-intensity tuples within the copy of the training chromatogram 1002, wherein the void dip is present within such sub-sequence. In various aspects, the training component 802 can contract the void dip of that copy by manipulating the retention time values of that sub-sequence while maintaining or leaving unchanged the intensity values and the relative ordering of that sub-sequence.

As a non-limiting example, using the above-explained notation, the retention times of that sub-sequence can be considered as ranging from A to B in chronological order and with even or linear spacing. In some situations, the training component 802 can replace those retention time values, such that they now range from A to C for any suitable positive retention time A<C<B with even or linear spacing and are still in the same chronological order. To maintain uniform dimensionality, the training component 802 can remove or omit any time-intensity tuples from such manipulated sub-sequence whose retention times were not in the original sub-sequence, and the training component 802 can concatenate to the end of that manipulated subsequence time-intensity tuples whose retention times are evenly or linearly spaced from C to B and whose intensity values are obtained via interpolation (e.g., by interpolating between the intensity value at the retention time C to the first intensity value that is located rightward of the retention time B. This can be considered as deformably squeezing the void dip shown in the copy of the training chromatogram 1002 leftward toward (but not past) the retention time A. In other situations, the training component 802 can replace the retention time values of that original sub-sequence, such that they now range from C to B with even or linear spacing and are still in the same chronological order. To maintain uniform dimensionality, the training component 802 can remove or omit any time-intensity tuples from such manipulated sub-sequence whose retention times were not in the original sub-sequence, and the training component 802 can concatenate to the beginning of that manipulated subsequence time-intensity tuples whose retention times are evenly or linearly spaced from A to C and whose intensity values are obtained via interpolation (e.g., by interpolating between the intensity value at the retention time C to the first intensity value that is located leftward of the retention time A. This can be considered as deformably squeezing the void dip shown in the copy of the training chromatogram 1002 rightward toward (but not past) the retention time B.

In any case, the manipulated copy of the training chromatogram 1002 can be referred to as the augmented training chromatogram 1102. By locally scaling (e.g., vertically or horizontally) the time-intensity tuples of the copy of the training chromatogram 1002 that fall inside of the training characteristic void location 1004, the augmented training chromatogram 1102 can be considered as being forced to have a taller, shorter, skinnier, less heavy, or otherwise spatially deformed void dip as compared to the training chromatogram 1002, while otherwise being identical to the training chromatogram 1002 (e.g., all time-intensity tuples of the augmented training chromatogram 1102 that fall outside of the training characteristic void location 1004 can be identical to those in the training chromatogram 1002). Thus, the training characteristic void location 1004 and the ground-truth near-void peak localization 1006 can still be considered as applicable to the augmented training chromatogram 1102. Therefore, the training component 802 can insert the augmented training chromatogram 1102, a copy of the training characteristic void location 1004, and a copy of the ground-truth near-void peak localization 1006 as a new entry into the void-based training dataset 804. By augmenting the training chromatograms in this way, the void-based training dataset 804 can be expanded so as to increase or represent even more diversity in void dip size or void dip location. In this way, a robustness or resilience of the peak-detection machine learning model 602 can be even further increased.

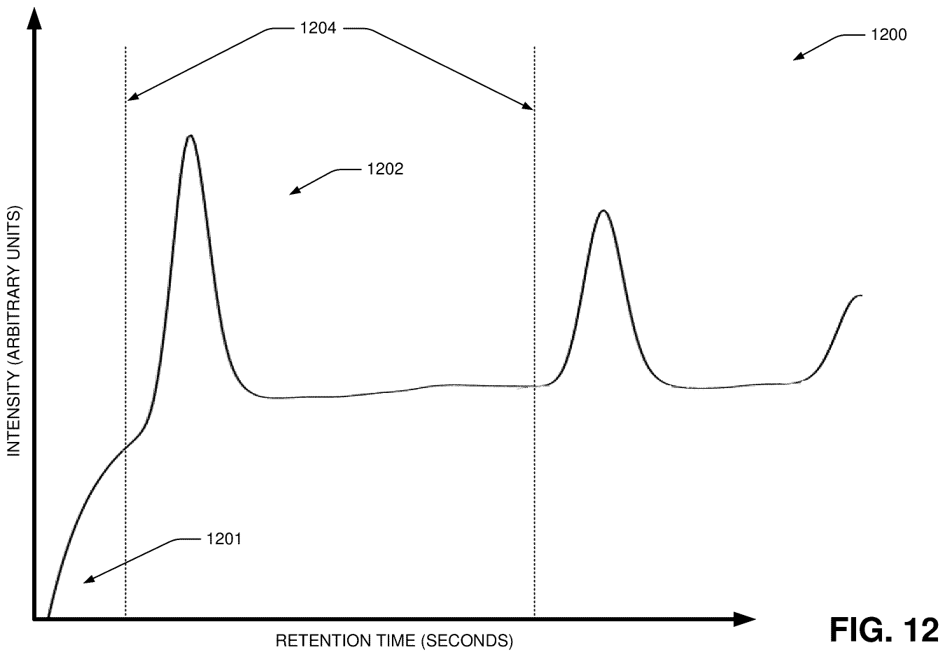

FIGS. 12-15 illustrate graphical recreations of example, non-limiting experimental results in accordance with one or more embodiments described herein.

First, consider FIG. 12, which shows a zoomed graphical recreation of a chromatogram 1200. The chromatogram 1200 includes a void dip 1201 and a near-void peak 1202. As shown, the near-void peak 1202 has a height that can be considered as commensurate with (e.g., on the same order of magnitude as) that of the void dip. In other words, the near-void peak 1202 is not exceedingly small or inconspicuous. The present inventors conducted a real-world experiment in which peak localization was performed on the chromatogram 1200 using a heuristic protocol according to existing techniques. Such heuristic protocol identified for the near-void peak 1202 integration limits 1204. The integration limits 1204 are denoted as two vertical dotted lines, the left-most one of which demarcates the starting retention time that was inferred by existing techniques for the near-void peak 1202, and the right-most one of which demarcates the ending retention time that was inferred by existing techniques for the near-void peak 1202. As shown, the ending retention time was grossly overestimated. In other words, the existing techniques erroneously inferred that the near-void peak 1202 ends much later than it actually does.

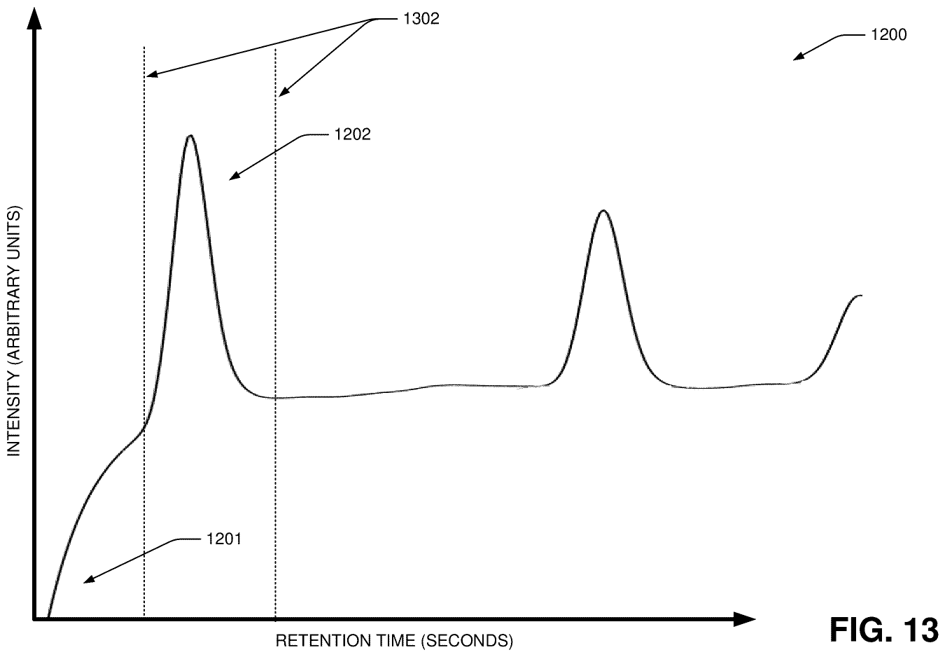

Next, consider FIG. 13, which shows the same zoomed graphical recreation of the chromatogram 1200. During the above real-world experiment, peak localization was performed on the chromatogram 1200 using various embodiments described herein. Such embodiments identified for the near-void peak 1202 integration limits 1302. The integration limits 1302 are denoted as two vertical dotted lines, the left-most one of which demarcates the starting retention time that was inferred by the peak-detection machine learning model 602 for the near-void peak 1202, and the right-most one of which demarcates the ending retention time that was inferred by the peak-detection machine learning model 602 for the near-void peak 1202. As shown, the ending retention time predicted by the peak-detection machine learning model 602 is much more reasonable (e.g., is not grossly overestimated or excessively past the true end of the near-void peak 1202), unlike that inferred by existing techniques.

Now, consider FIG. 14, which shows a zoomed graphical recreation of a chromatogram 1400. The chromatogram 1400 includes a void dip 1401, a near-void peak 1402, and a non-near-void peak 1404. As shown, the near-void peak 1402 has a height that can be considered as not being commensurate with (e.g., as being one or more orders of magnitude smaller than) that of the void dip. In other words, the near-void peak 1402 is quite small or inconspicuous. The present inventors conducted an real-world experiment in which peak localization was performed on the chromatogram 1400 using a heuristic protocol according to existing techniques. Such heuristic protocol localized the non-near-void peak 1404 as being closest or nearest to the void dip 1401. Specifically, such heuristic protocol identified for the non-near-void peak 1404 integration limits 1406. Although the integration limits 1406 are reasonable for the non-near-void peak 1404, such heuristic protocol did not produce any integration limits whatsoever for the near-void peak 1402. In other words, the existing techniques erroneously mistook the near-void peak 1402 as being part of the void dip 1401.

Next, consider FIG. 15, which shows the same zoomed graphical recreation of the chromatogram 1400. During the above real-world experiment, peak localization was performed on the chromatogram 1400 using various embodiments described herein. Such embodiments identified for the near-void peak 1402 integration limits 1502. That is, the peak-detection machine learning model 602 correctly localized the near-void peak 1402, notwithstanding that the near-void peak 1402 is so small that it was not localized at all by the heuristic protocol.

These real-world experiments demonstrate that various embodiments described herein can exhibit significantly increased robustness or resilience to void interference, as compared to existing techniques.

Although various embodiments are described herein in which the peak-detection machine learning model 602 is configured to localize chromatographic peaks that are closest or nearest to void dips, these are mere non-limiting examples for ease of illustration and explanation. In various aspects, the peak-detection machine learning model 602 can be configured to localize any other suitable chromatographic peaks in addition to near-void peaks. In other words, when given a chromatogram, the peak-detection machine learning model 602 can be configured to localize the one peak in that given chromatogram that is closest or nearest to a void dip of that given chromatogram, but the peak-detection machine learning model 602 can also be configured to localize any other additional peaks that are depicted in that given chromatogram (e.g., even peaks that are far away from the void dip).

Although various embodiments described herein refer to chromatograms as being sequences of intensities that are organized according to retention time, these are mere non-limiting examples for ease of explanation and illustration. In various aspects, retention time in any embodiment can be readily replaced with a unitless retention index as appropriate.

In order to provide additional context for various embodiments described herein, FIG. 16 and the following discussion are intended to provide a brief, general description of a suitable computing environment 1600 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and a drive 1620, e.g., such as a solid state drive, an optical disk drive, which can read or write from a disk 1622, such as a CD-ROM disc, a DVD, a BD, etc. Alternatively, where a solid state drive is involved, disk 1622 would not be included, unless separate. While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and drive 1620 can be connected to the system bus 1608 by an HDD interface 1624, an external storage interface 1626 and a drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the . NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enable with a security module, such as a trusted processing module (TPM). For instance with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above, such as but not limited to a network virtual machine providing one or more aspects of storage or processing of information. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 17 is a schematic block diagram of a sample computing environment 1700 with which the disclosed subject matter can interact. The sample computing environment 1700 includes one or more client(s) 1710. The client(s) 1710 can be hardware or software (e.g., threads, processes, computing devices). The sample computing environment 1700 also includes one or more server(s) 1730. The server(s) 1730 can also be hardware or software (e.g., threads, processes, computing devices). The servers 1730 can house threads to perform transformations by employing one or more embodiments as described herein, for example. One possible communication between a client 1710 and a server 1730 can be in the form of a data packet adapted to be transmitted between two or more computer processes. The sample computing environment 1700 includes a communication framework 1750 that can be employed to facilitate communications between the client(s) 1710 and the server(s) 1730. The client(s) 1710 are operably connected to one or more client data store(s) 1720 that can be employed to store information local to the client(s) 1710. Similarly, the server(s) 1730 are operably connected to one or more server data store(s) 1740 that can be employed to store information local to the servers 1730.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects are described in the following examples.
EXAMPLE 1: A system can comprise a processor that can execute computer-executable components stored in a non-transitory computer-readable memory, wherein the computer-executable components can comprise: a scan component that can access a chromatogram of a sample scanned by a chromatograph; and a peak component that can identify for the sample a chromatographic peak based on executing a peak-detection machine learning model on the chromatogram, wherein the peak-detection machine learning model can be trained on a training dataset whose annotated chromatograms collectively exhibit a range of void dip sizes or void dip locations.
EXAMPLE 2: The system of any preceding example can be implemented, wherein the chromatographic peak can be nearest to a void dip of the chromatogram, wherein the peak-detection machine learning model can receive as input the chromatogram and a characteristic location of the void dip associated with the chromatograph, and wherein the peak-detection machine learning model can produce as output predicted integration limits for the chromatographic peak that is nearest to the void dip.
EXAMPLE 3: The system of any preceding example can be implemented, wherein the peak-detection machine learning model can further produce as output a predicted retention time for the chromatographic peak that is nearest to the void dip.
EXAMPLE 4: The system of any preceding example can be implemented, wherein the computer-executable components can comprise: an execution component that can render the predicted integration limits and the predicted retention time on an electronic display.
EXAMPLE 5: The system of any preceding example can be implemented, wherein the execution component can integrate the chromatogram between the predicted integration limits, thereby yielding an area-under-curve value for the chromatographic peak that is nearest to the void dip, and wherein the execution component can render the area-under-curve value on the electronic display.
EXAMPLE 6: The system of any preceding example can be implemented, wherein the computer-executable components can comprise: a training component that can expand the training dataset, based on copying annotated chromatograms and locally scaling respective void dips exhibited by copied annotated chromatograms.
EXAMPLE 7: The system of any preceding example can be implemented, wherein the local scaling can include vertically heightening or shortening the respective void dips exhibited by copied annotated chromatograms.
EXAMPLE 8: The system of any preceding example can be implemented, wherein the local scaling can include horizontally contracting the respective void dips exhibited by copied annotated chromatograms.

In various embodiments, any combination or combinations of examples 1-8 can be implemented.
EXAMPLE 9: A computer-implemented method can comprise: accessing, by a device operatively coupled to a processor, a chromatogram of a sample scanned by a chromatograph; and identifying, by the device, for the sample a chromatographic peak based on executing a peak-detection machine learning model on the chromatogram, wherein the peak-detection machine learning model is trained on a training dataset whose annotated chromatograms collectively exhibit a range of void dip sizes or void dip locations.
EXAMPLE 10: The computer-implemented method of any preceding example can be implemented, wherein the chromatographic peak can be nearest to a void dip of the chromatogram, wherein the peak-detection machine learning model can receive as input the chromatogram and a characteristic location of the void dip associated with the chromatograph, and wherein the peak-detection machine learning model can produce as output predicted integration limits for the chromatographic peak that is nearest to the void dip.
EXAMPLE 11: The computer-implemented method of any preceding example can be implemented, wherein the peak-detection machine learning model can further produce as output a predicted retention time for the chromatographic peak that is nearest to the void dip.
EXAMPLE 12: The computer-implemented method of any preceding example can be implemented, further comprising: rendering, by the device, the predicted integration limits and the predicted retention time on an electronic display.
EXAMPLE 13: The computer-implemented method of any preceding example can be implemented, further comprising: integrating, by the device, the chromatogram between the predicted integration limits, thereby yielding an area-under-curve value for the chromatographic peak that is nearest to the void dip; and rendering, by the device, the area-under-curve value on the electronic display.
EXAMPLE 14: The computer-implemented method of any preceding example can be implemented, further comprising: expanding, by the device, the training dataset, based on copying annotated chromatograms and locally scaling respective void dips exhibited by copied annotated chromatograms.
EXAMPLE 15: The computer-implemented method of any preceding example can be implemented, wherein the local scaling can include vertically heightening or shortening the respective void dips exhibited by copied annotated chromatograms.
EXAMPLE 16: The computer-implemented method of any preceding example can be implemented, wherein the local scaling can include horizontally contracting the respective void dips exhibited by copied annotated chromatograms.

In various embodiments, any combination or combinations of examples 9-16 can be implemented.
EXAMPLE 17: A computer program product for facilitating void-based machine learning localization of chromatographic peaks can comprise a non-transitory computer-readable memory having program instructions embodied therewith. In various aspects, the program instructions can be executable by a processor to cause the processor to: cause a chromatograph to scan a sample, thereby yielding a chromatogram; predict integration limits and a retention time for a chromatographic peak that is nearest to a void dip of the chromatogram, based on executing a peak-detection machine learning model on the chromatogram, wherein the peak-detection machine learning model can be trained on a training dataset whose annotated chromatograms collectively exhibit a range of void dip sizes or void dip locations; and render the integration limits and the retention time of the chromatographic peak that is nearest to the void dip on an electronic display.
EXAMPLE 18: The computer program product of any preceding example can be implemented, wherein the peak-detection machine learning model can receive as input the chromatogram and a characteristic location of the void dip associated with the chromatograph.
EXAMPLE 19: The computer program product of any preceding example can be implemented, wherein the program instructions can be executable to cause the processor to: expand the training dataset, based on copying annotated chromatograms and heightening, shortening, or contracting respective void dips exhibited by copied annotated chromatograms.
EXAMPLE 20: The computer program product of any preceding example can be implemented, wherein the program instructions can be executable to cause the processor to: integrate the chromatogram between the integration limits, thereby yielding an area value covered by the chromatographic peak that is nearest to the void dip; and render the area value on the electronic display.

In various embodiments, any combination or combinations of examples 17-20 can be implemented.

In various embodiments, any combination or combinations of examples 1-20 can be implemented.

What is claimed is:

1. A system, comprising:
a processor that executes computer-executable components stored in a non-transitory computer-readable memory, wherein the computer-executable components comprise:
a scan component that accesses a chromatogram of a sample scanned by a chromatograph; and
a peak component that identifies for the sample a chromatographic peak based on executing a peak-detection machine learning model on the chromatogram, wherein the peak-detection machine learning model is trained on a training dataset whose annotated chromatograms collectively exhibit a range of void dip sizes or void dip locations.

2. The system of claim 1, wherein the chromatographic peak is nearest to a void dip of the chromatogram, wherein the peak-detection machine learning model receives as input the chromatogram and a characteristic location of the void dip associated with the chromatograph, and wherein the peak-detection machine learning model produces as output predicted integration limits for the chromatographic peak that is nearest to the void dip.

3. The system of claim 2, wherein the peak-detection machine learning model further produces as output a predicted retention time for the chromatographic peak that is nearest to the void dip.

4. The system of claim 3, wherein the computer-executable components comprise:
an execution component that renders the predicted integration limits and the predicted retention time on an electronic display.

5. The system of claim 4, wherein the execution component integrates the chromatogram between the predicted integration limits, thereby yielding an area-under-curve value for the chromatographic peak that is nearest to the void dip, and wherein the execution component renders the area-under-curve value on the electronic display.

6. The system of claim 1, wherein the computer-executable components comprise:
a training component that expands the training dataset, based on copying annotated chromatograms and locally scaling respective void dips exhibited by copied annotated chromatograms.

7. The system of claim 6, wherein the local scaling includes vertically heightening or shortening the respective void dips exhibited by copied annotated chromatograms.

8. The system of claim 1, wherein the local scaling includes horizontally contracting the respective void dips exhibited by copied annotated chromatograms.

9. A computer-implemented method, comprising:
accessing, by a device operatively coupled to a processor, a chromatogram of a sample scanned by a chromatograph; and
identifying, by the device, for the sample a chromatographic peak based on executing a peak-detection machine learning model on the chromatogram, wherein the peak-detection machine learning model is trained on a training dataset whose annotated chromatograms collectively exhibit a range of void dip sizes or void dip locations.

10. The computer-implemented method of claim 9, wherein the chromatographic peak is nearest to a void dip of the chromatogram, wherein the peak-detection machine learning model receives as input the chromatogram and a characteristic location of the void dip associated with the chromatograph, and wherein the peak-detection machine learning model produces as output predicted integration limits for the chromatographic peak that is nearest to the void dip.

11. The computer-implemented method of claim 10, wherein the peak-detection machine learning model further produces as output a predicted retention time for the chromatographic peak that is nearest to the void dip.

12. The computer-implemented method of claim 11, further comprising:
rendering, by the device, the predicted integration limits and the predicted retention time on an electronic display.

13. The computer-implemented method of claim 12, further comprising:
integrating, by the device, the chromatogram between the predicted integration limits, thereby yielding an area-under-curve value for the chromatographic peak that is nearest to the void dip; and
rendering, by the device, the area-under-curve value on the electronic display.

14. The computer-implemented method of claim 9, further comprising:
expanding, by the device, the training dataset, based on copying annotated chromatograms and locally scaling respective void dips exhibited by copied annotated chromatograms.

15. The computer-implemented method of claim 14, wherein the local scaling includes vertically heightening or shortening the respective void dips exhibited by copied annotated chromatograms.

16. The computer-implemented method of claim 9, wherein the local scaling includes horizontally contracting the respective void dips exhibited by copied annotated chromatograms.

17. A computer program product for facilitating void-based machine learning localization of chromatographic peaks, the computer program product comprising a non-transitory computer-readable memory having program instructions embodied therewith, the program instructions executable by a processor to cause the processor to:
cause a chromatograph to scan a sample, thereby yielding a chromatogram;
predict integration limits and a retention time for a chromatographic peak that is nearest to a void dip of the chromatogram, based on executing a peak-detection machine learning model on the chromatogram, wherein the peak-detection machine learning model is trained on a training dataset whose annotated chromatograms collectively exhibit a range of void dip sizes or void dip locations; and
render the integration limits and the retention time of the chromatographic peak that is nearest to the void dip on an electronic display.

18. The computer program product of claim 17, wherein the peak-detection machine learning model receives as input the chromatogram and a characteristic location of the void dip associated with the chromatograph.

19. The computer program product of claim 17, wherein the program instructions are executable to cause the processor to:
expand the training dataset, based on copying annotated chromatograms and heightening, shortening, or contracting respective void dips exhibited by copied annotated chromatograms.

20. The computer program product of claim 17, wherein the program instructions are executable to cause the processor to:
integrate the chromatogram between the integration limits, thereby yielding an area value covered by the chromatographic peak that is nearest to the void dip; and
render the area value on the electronic display.
